(19) United States
(12) Patent Application Publication
(10) Pub. No.: US 2004/0184670 A1
(43) Pub. Date: Sep. 23, 2004

(54) Detection correction of red-eye features in digital images

(76) Inventors: Nick Jarman, Hampshire (GB); Richard Lafferty, Guildford (GB); Marion Archibald, Guildford (GB); Daniel Normington, Guildford (GB); Mike Stroud, Guildford (GB); Nigel Biggs, Guildford (GB)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/475,536

(22) PCT Filed: Feb. 19, 2003
(86) PCT No.: PCT/GB03/00767

(30) Foreign Application Priority Data
Feb. 22, 2002 (GB) 0204191.1
Oct. 16, 2002 (GB) 0224054.7

(51) Int. Cl. G06K 9/40; G06K 9/46; G06K 9/00

(52) U.S. Cl. 382/274; 382/190; 382/117

(57) ABSTRACT

A method of correcting red-eye features in a digital image includes generating a list of possible features by scanning through each pixel in the image searching for saturation and/or lightness profiles characteristic of red-eye features. For each feature in the list, an attempt is made to find an isolated area of correctable pixels which could correspond to a red-eye feature. Each successful attempt is recorded in a list of areas. Each area is then analysed to calculate statistics and record properties of that area, and validated using the calculated statistics and properties to determine whether or not that area is caused by red-eye. Areas not caused by red-eye and overlapping areas are removed from the list. Each area remaining is corrected to reduce the effect of red-eye. More than one type of feature may be identified in the initial search for features.

This invention relates to the detection and correction of red-eye in digital images.

The phenomenon of red-eye in photographs is well known. When a flash is used to illuminate a person (or animal), the light is often reflected directly from the subject's retina back into the camera. This causes the subject's eyes to appear red when the photograph is displayed or printed.

Photographs are increasingly stored as digital images, typically as arrays of pixels, where each pixel is normally represented by a 24-bit value. The colour of each pixel may be encoded within the 24-bit value as three 8-bit values representing the intensity of red, green and blue for that pixel. Alternatively, the array of pixels can be transformed so that the 24-bit value consists of three 8-bit values representing “hue”, “saturation” and “lightness”. Hue provides a “circular” scale defining the colour, so that 0 represents red, with the colour passing through green and blue as the value increases, back to red at 255. Saturation provides a measure (from 0 to 255) of the intensity of the colour identified by the hue. Lightness can be seen as a measure (from 0 to 255) of the amount of illumination. “Pure” colours have a lightness value half way between black (0) and white (255). For example pure red (having a red intensity of 255 and green and blue intensities of 0) has a hue of 0, a lightness of 128 and a saturation of 255. A lightness of 255 will lead to a “white” colour. Throughout this document, when values are given for “hue”, “saturation” and “lightness” they refer to the scales as defined in this paragraph.

By manipulation of these digital images it is possible to reduce the effects of red-eye. Software that performs this task is well known, and generally works by altering the pixels of a red-eye feature so that their red content is reduced. This is performed by modifying their hue so that it is less red—it is rotated away from the red part of the (circular) hue spectrum—or their saturation is substantially reduced. Typically the pixels are left as black or dark grey instead.

Most red-eye reduction software requires as input the centre and radius of each red-eye feature that is to be manipulated, and the simplest way to capture this information is to require the user to select the central pixel of each red-eye feature and indicate the radius of the red part. This process can be performed for each red-eye feature, and the manipulation therefore has no effect on the rest of the image. However, this requires careful and accurate input from the user; it is difficult to pinpoint the precise centre of each red-eye feature and to select the correct radius. An alternative method that is common is for the user to draw a box around the red area. This is rectangular, making it even more difficult to accurately mark the feature.

Given the above, it will be readily seen that it is desirable to be able to identify automatically areas of a digital image to which red-eye reduction should be applied. This should facilitate red-eye reduction being applied only where it is needed, and should do so with minimal or, more preferably, no intervention from a user.

In the following description it will be understood that references to rows of pixels are intended to include columns of pixels, and that references to movement left and right along rows is intended to include movement up and down along columns. The definitions “left”, “right”, “up” and “down” depend entirely on the co-ordinate system used.

The present invention recognises that red-eye features are not all similarly characterised, but may be usefully divided into several types according to particular attributes. This invention therefore includes more than one method for detecting and locating the presence of red-eye features in an image.

In accordance with one aspect of the present invention there is provided a method of detecting red-eye features in a digital image, comprising:

identifying pupil regions in the image by searching for a row of pixels having a predetermined saturation and/or lightness profile;

identifying further pupil regions in the image by searching for a row of pixels having a different predetermined saturation and/or lightness profile; and

determining whether each pupil region corresponds to part of a red-eye feature on the basis of further selection criteria.

Thus different types of red-eye features are detected, increasing the chances that all of the red-eye features in the image will be identified. This also allows the individual types of saturation and/or lightness profiles associated with red-eye features to be specifically characterised, reducing the chances of false detections.

Preferably two or more types of pupil regions are identified, a pupil region in each type being identified by a row of pixels having a saturation and/or lightness profile characteristic of that type.

Red-eye features are not simply regions of red pixels. One type of red-eye feature also includes a bright spot caused by reflection of the flashlight from the front of the eye. These bright spots are known as “highlights”. If highlights in the image can be located then red-eyes are much easier to identify automatically. Highlights are usually located near the centre of red-eye features, although sometimes they lie off-centre, and occasionally at the edge. Other types of red-eye features do not include these highlights.

A first type of identified pupil region may have a saturation profile including a region of pixels having higher saturation than the pixels therearound. This facilitates the simple detection of highlights. The saturation/lightness contrast between highlight regions and the area surrounding them is much more marked than the colour (or “hue”) contrast between the red part of a red-eye feature and the skin tones surrounding it. Furthermore, colour is encoded at a low resolution for many image compression formats such as JPEG. By using saturation and lightness to detect red-eyes it is easier to identify regions which might correspond to red-eye features.

Not all highlights will be clear, easily identifiable, bright spots measuring many pixels across in the centre of the subject's eye. In some cases, especially if the subject is some distance from the camera, the highlight may be only a few pixels, or even less than one pixel, across. In such cases, the whiteness of the highlight can dilute the red of the pupil. However, it is still possible to search for characteristic saturation and lightness “profiles” of such highlights.

A second type of identified pupil region may have a saturation profile including a saturation trough bounded by two saturation peaks, the pixels in the saturation peaks having higher saturation than the pixels in the area outside the saturation peaks, and preferably a peak in lightness corresponding to the trough in saturation.

A third type of pupil region may have a lightness profile including a region of pixels whose lightness values form a “W” shape.

As mentioned above, some types of red-eye feature have no highlight at all. These are known as “flared” red-eyes or “flares”. These include eyes where the pupil is well dilated and the entire pupil has high lightness. In addition, the range of hues in flares is generally wider than that of the previous three types. Some pixels can appear orange and yellow. There is also usually a higher proportion of white or very light pink pixels in a flare. These are harder to detect than first, second and third types described above.

A fourth type of identified pupil region may have a saturation and lightness profile including a region of pixels bounded by two local saturation minima, wherein:

at least one pixel in the pupil region has a saturation higher than a predetermined saturation threshold;

the saturation and lightness curves of pixels in the pupil region cross twice; and

two local lightness minima are located in the pupil region.

A suitable value for the predetermined saturation threshold is about 200.

Preferably the saturation/lightness profile of the fourth type of identified pupil further requires that the saturation of at least one pixel in the pupil region is at least 50 greater than the lightness of that pixel, the saturation of the pixel at each local lightness minimum is greater than the lightness of that pixel, one of the local lightness minima includes the pixel having the lowest lightness in the pupil region, and the lightness of at least one pixel in the pupil region is greater than a predetermined lightness threshold. It may further be required that the hue of the at least one pixel having a saturation higher than a predetermined threshold is greater than about 210 or less than about 20.

A fifth type of pupil region may have a saturation and lightness profile including a high saturation region of pixels having a saturation above a predetermined threshold and bounded by two local saturation minima, wherein:

the saturation and lightness curves of pixels in the pupil region cross twice at crossing pixels;

the saturation is greater than the lightness for all pixels between the crossing pixels; and

two local lightness minima are located in the pupil region.

Preferably the saturation/lightness profile for the fifth type of pupil region further includes the requirement that the saturation of pixels in the high saturation region is above about 100, that the hue of pixels at the edge of the high saturation region is greater than about 210 or less than about 20, and that no pixel up to four outside each local lightness minimum has a lightness lower than the pixel at the corresponding local lightness minimum.

Having identified features characteristic of red-eye pupils, it is necessary to determine whether there is a “correctable” area associated with the feature caused by red-eye, and if so, to correct it.

In accordance with another aspect of the present invention there is provided a method of correcting red-eye features in a digital image, comprising:

generating a list of possible features by scanning through each pixel in the image searching for saturation and/or lightness profiles characteristic of red-eye features;

for each feature in the list of possible features, attempting to find an isolated area of correctable pixels which could correspond to a red-eye feature;

recording each successful attempt to find an isolated area in a list of areas;

analysing each area in the list of areas to calculate statistics and record properties of that area;

validating each area using the calculated statistics and properties to determine whether or not that area is caused by red-eye;

removing from the list of areas those which are not caused by red-eye;

removing some or all overlapping areas from the list of areas; and

correcting some or all pixels in each area remaining in the list of areas to reduce the effect of red-eye.

The step of generating a list of possible features is preferably performed using the methods described above.

In accordance with a further aspect of the present invention there is provided a method of correcting an area of correctable pixels corresponding to a red-eye feature in a digital image, comprising:

constructing a rectangle enclosing the area of correctable pixels;

determining a saturation multiplier for each pixel in the rectangle, the saturation multiplier calculated on the basis of the hue, lightness and saturation of that pixel;

determining a lightness multiplier for each pixel in the rectangle by averaging the saturation multipliers in a grid of pixels surrounding that pixel;

modifying the saturation of each pixel in the rectangle by an amount determined by the saturation multiplier of that pixel; and

modifying the lightness of each pixel in the rectangle by an amount determined by the lightness multiplier of that pixel.

Preferably, this is the method used to correct each area in the list of areas referred to above.

The determination of the saturation multiplier for each pixel preferably includes:

on a 2D grid of saturation against lightness, calculating the distance of the pixel from a calibration point having predetermined lightness and saturation values;

if the distance is greater than a predetermined threshold, setting the saturation multiplier to be 0 so that the saturation of that pixel will not be modified; and

if the distance is less than or equal to the predetermined threshold, calculating the saturation multiplier based on the distance from the calibration point so that it approaches 1 when the distance is small, and 0 when the distance approaches the threshold, so that the multiplier is 0 at the threshold and 1 at the calibration point

In a preferred embodiment the calibration point has lightness 128 and saturation 255, and the predetermined threshold is about 180. In addition, the saturation multiplier for a pixel is preferably set to 0 if that pixel is not “red”—i.e. if the hue is between about 20 and about 220.

A radial adjustment is preferably applied to the saturation multipliers of pixels in the rectangle, the radial adjustment comprising leaving the saturation multipliers of pixels inside a predetermined circle within the rectangle unchanged, and smoothly graduating the saturation multipliers of pixels outside the predetermined circle from their previous values at the predetermined circle to 0 at the corners of the rectangle. This radial adjustment helps to ensure the smoothness of the correction, so that there are no sharp changes in saturation at the edge of the eye.

A similar radial adjustment is preferably also carried out on the lightness multipliers, although based on a different predetermined circle.

In order to further smooth the edges, a new saturation multiplier may be calculated, for each pixel immediately outside the area of correctable pixels, by averaging the value of the saturation multipliers of pixels in a 3×3 grid around that pixel. A similar smoothing process is preferably carried out on the lightness multipliers, once for the pixels around the edge of the correctable area and once for all of the pixels in the rectangle.

The lightness multiplier of each pixel is preferably scaled according to the mean of the saturation multipliers for all of the pixels in the rectangle.

The step of modifying the saturation of each pixel preferably includes:

if the saturation of the pixel is greater than or equal to 200, setting the saturation of the pixel to 0; and

if the saturation of the pixel is less than 200, modifying the saturation of the pixel such that the modified saturation=(saturation×(1−saturation multiplier))+(saturation multiplier×64).

The step of modifying the lightness of each pixel preferably includes:

if the saturation of the pixel is not zero and the lightness of the pixel is less than 220, modifying the lightness such that modified lightness=lightness×(1−lightness multiplier).

In order to further reduce the amount of red in the red-eye feature, a further reduction to the saturation of each pixel may be applied if, after the modification of the saturation and lightness of the pixel described above, the red value of the pixel is higher than both the green and blue values.

Even after the correction described above, some red-eye features may still not look natural. Generally, such eyes do not have a highlight and, when corrected, are predominantly made up of light, unsaturated pixels. The correction method therefore preferably includes modifying the saturation and lightness of the pixels in the area to give the effect of a bright highlight region and dark pupil region therearound if the area, after correction, does not already include a bright highlight region and dark pupil region therearound.

This may be effected by determining if the area, after correction, substantially comprises pixels having high lightness and low saturation, simulating a highlight region comprising a small number of pixels within the area, modifying the lightness and saturation values of the pixels in the simulated highlight region so that the simulated highlight region comprises pixels with high saturation and lightness, and reducing the lightness values of the pixels in the area outside the simulated highlight region so as to give the effect of a dark pupil.

It will be appreciated that the addition of a highlight to improve the look of a corrected red-eye can be used with any red-eye detection and/or correction method. According to another aspect of the present invention, therefore, there is provided a method of correcting a red-eye feature in a digital image, comprising adding a simulated highlight region of light pixels to the red-eye feature. The saturation value of pixels in the simulated highlight region may be increased.

Preferably the pixels in a pupil region around the simulated highlight region are darkened. This may be effected by:

identifying a flare region of pixels having high lightness and low saturation;

eroding the edges of the flare region to determine the simulated highlight region;

decreasing the lightness of the pixels in the flare region; and

increasing the saturation and lightness of the pixels in the simulated highlight region.

The correction need not be performed if a highlight region of very light pixels is already present in the red-eye feature.

It will be appreciated that it is not necessary to detect a red-eye feature automatically in order to correct it. The correction method just described may therefore be applied to red-eye features identified by the user, as well as to features identified using the automatic detection method outlined above.

Similarly, the step of identifying a red area prior to correction could be performed for features detected automatically, or for features identified by the user.

In accordance with another aspect of the present invention, there is provided a method of detecting red-eye features in a digital image, comprising:

determining whether a red-eye feature could be present around a reference pixel in the image by attempting to identify an isolated, substantially circular area of correctable pixels around the reference pixel, a pixel being classed as correctable if it satisfies at least one set of predetermined conditions from a plurality of such sets.

One set of predetermined conditions may include the requirements that the hue of the pixel is greater than or equal to about 220 or less than or equal to about 10; the saturation of the pixel is greater than or equal to about 80; and the lightness of the pixel is less than about 200.

An additional or alternative set of predetermined conditions may include the requirements either that the saturation of the pixel is equal to 255 and the lightness of the pixel is greater than about 150; or that the hue of the pixel is greater than or equal to about 245 or less than or equal to about 20, the saturation of the pixel is greater than about 50, the saturation of the pixel is less than (1.8×lightness−92), the saturation of the pixel is greater than (1.1×lightness−90), and the lightness of the pixel is greater than about 100.

A further additional or alternative set of predetermined conditions may include the requirements that the hue of the pixel is greater than or equal to about 220 or less than or equal to about 10, and that the saturation of the pixel is greater than or equal to about 128.

The step of analysing each area in the list of areas preferably includes determining some or all of:

the mean of the hue, luminance and/or saturation of the pixels in the area;

the standard deviation of the hue, luminance and/or saturation of the pixels in the area;

the mean and standard deviation of the value of hue×saturation, hue×lightness and/or lightness×saturation of the pixels in the area;

the sum of the squares of differences in hue, luminance and/or saturation between adjacent pixels for all of the pixels in the area;

the sum of the absolute values of differences in hue, luminance and/or saturation between adjacent pixels for all of the pixels in the area;

a measure of the number of differences in lightness and/or saturation above a predetermined threshold between adjacent pixels;

a histogram of the number of correctable pixels having from 0 to 8 immediately adjacent correctable pixels;

a histogram of the number of uncorrectable pixels having from 0 to 8 immediately adjacent correctable pixels;

a measure of the probability of the area being caused by red-eye based on the probability of the hue, saturation and lightness of individual pixels being found in a red-eye feature; and

a measure of the probability of the area being a false detection of a red-eye feature based on the probability of the hue, saturation and lightness of individual pixels being found in a detected feature not caused by red-eye.

The measure of the probability of the area being caused by red-eye is preferably determined by evaluating the arithmetic mean, over all pixels in the area, of the product of the independent probabilities of the hue, lightness and saturation values of each pixel being found in a red-eye feature.

The measure of the probability of the area being a false detection is similarly preferably determined by evaluating the arithmetic mean, over all pixels in the area, of the product of the independent probabilities of the hue, lightness and saturation values of each pixel being found in detected feature not caused by red-eye.

Preferably an annulus outside the area is analysed, and the area categorised according to the hue, luminance and saturation of pixels in said annulus.

The step of validating the area preferably includes comparing the statistics and properties of the area with predetermined thresholds and tests, which may depend on the type of feature and area detected.

The step of removing some or all overlapping areas from the list of areas preferably includes:

comparing all areas in the list of areas with all other areas in the list;

if two areas overlap because they are duplicate detections, determining which area is the best to keep, and removing the other area from the list of areas;

if two areas overlap or nearly overlap because they are not caused by red-eye, removing both areas from the list of areas.

The invention also provides a digital image to which any of the methods described above have been applied, apparatus arranged to carry out any of the methods described above, and a computer storage medium having stored thereon a program arranged when executed to carry out any of the methods described above.

Thus the automatic removal of red-eye effects is possible using software and/or hardware that operates with limited or no human oversight or input. This includes, but is not limited to, personal computers, printers, digital printing mini-labs, cameras, portable viewing devices, PDAs, scanners, mobile phones, electronic books, public display systems (such as those used at concerts, football stadia etc.), video cameras, televisions (cameras, editing equipment, broadcasting equipment or receiving equipment), digital film editing equipment, digital projectors, head-up-display systems, and photo booths (for passport photos).

Some preferred embodiments of the invention will now be described by way of example only and with reference to the accompanying drawings, in which:

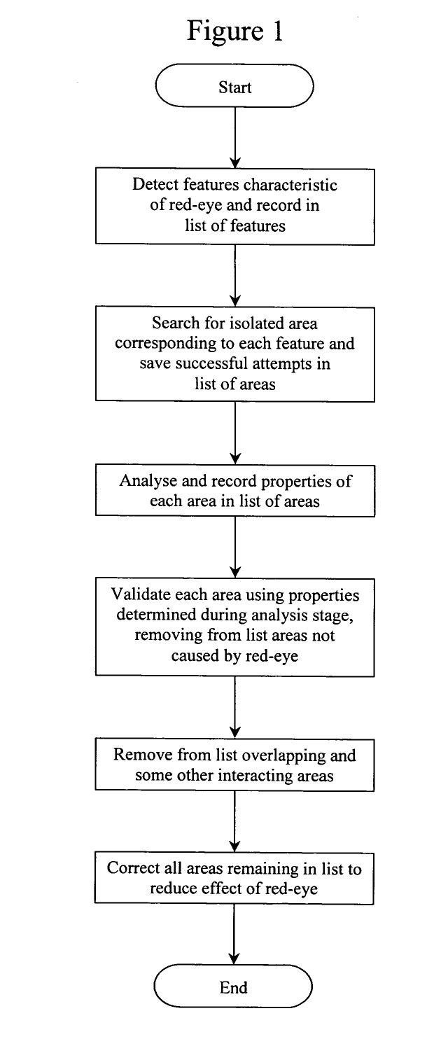

FIG. 1 is a flow diagram showing the detection and removal of red-eye features;

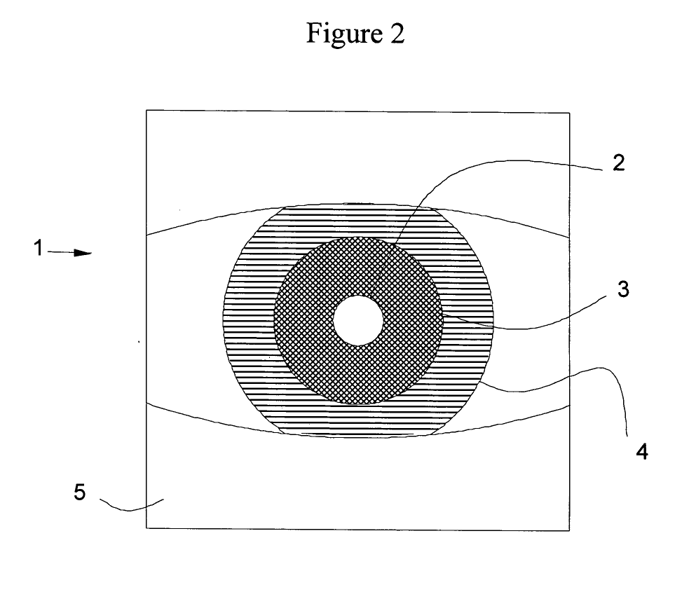

FIG. 2 is a schematic diagram showing a typical red-eye feature;

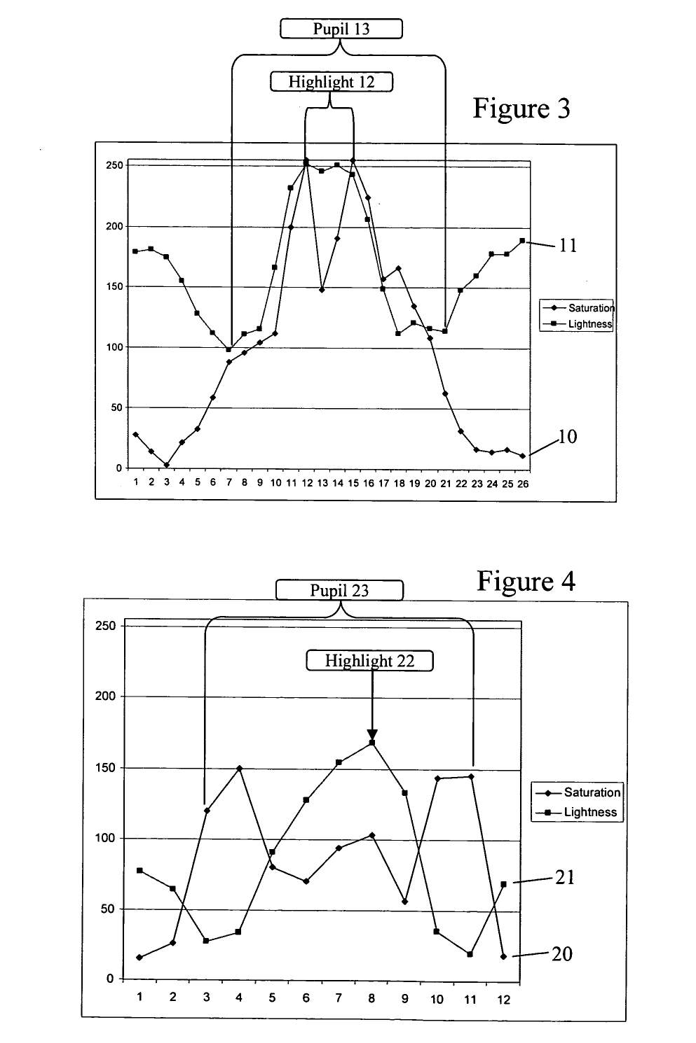

FIG. 3 is a graph showing the saturation and lightness behaviour of a typical type 1 feature;

FIG. 4 is a graph showing the saturation and lightness behaviour of a typical type 2 feature;

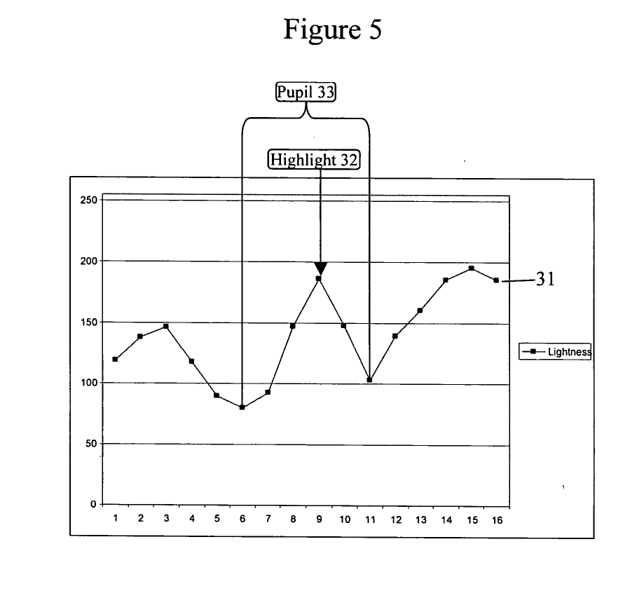

FIG. 5 is a graph showing the lightness behaviour of a typical type 3 feature;

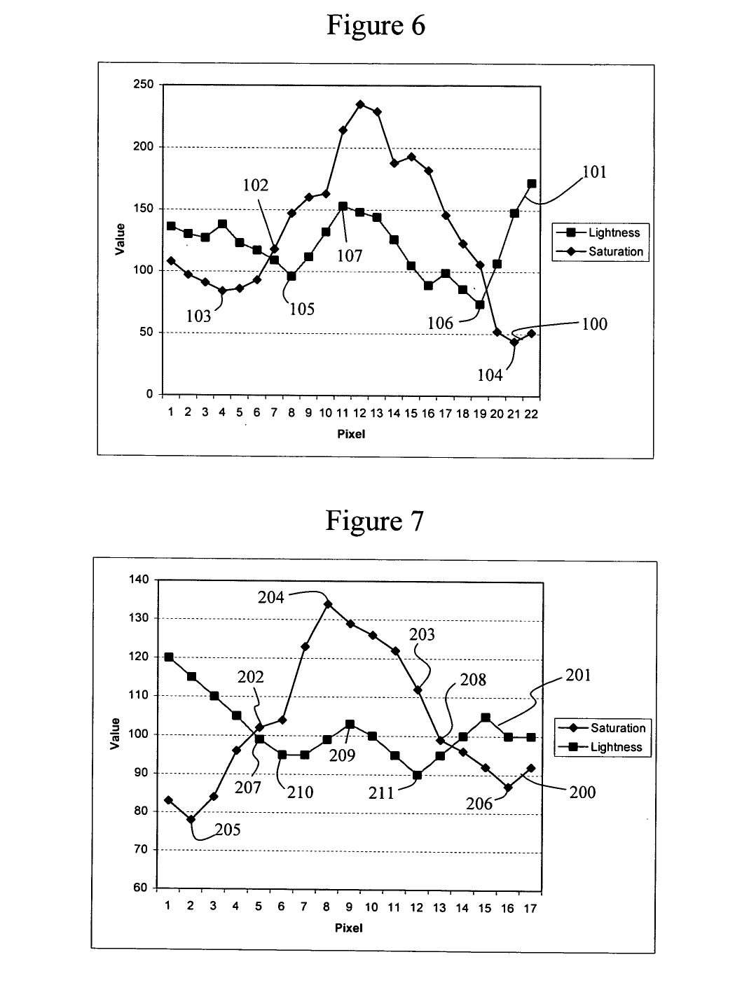

FIG. 6 is a graph showing the saturation and lightness behaviour of a typical type 4 feature;

FIG. 7 is a graph showing the saturation and lightness behaviour of a typical type 5 feature;

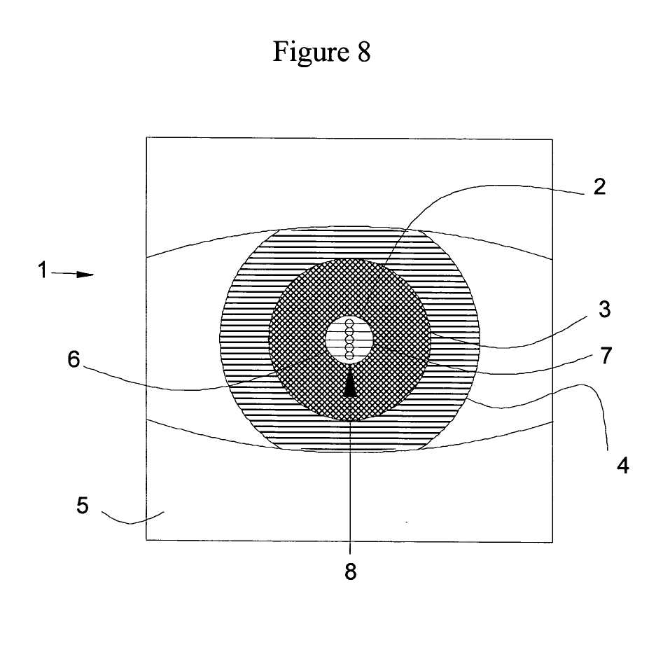

FIG. 8 is a schematic diagram of the red-eye feature of FIG. 2, showing pixels identified in the detection of a Type 1 feature;

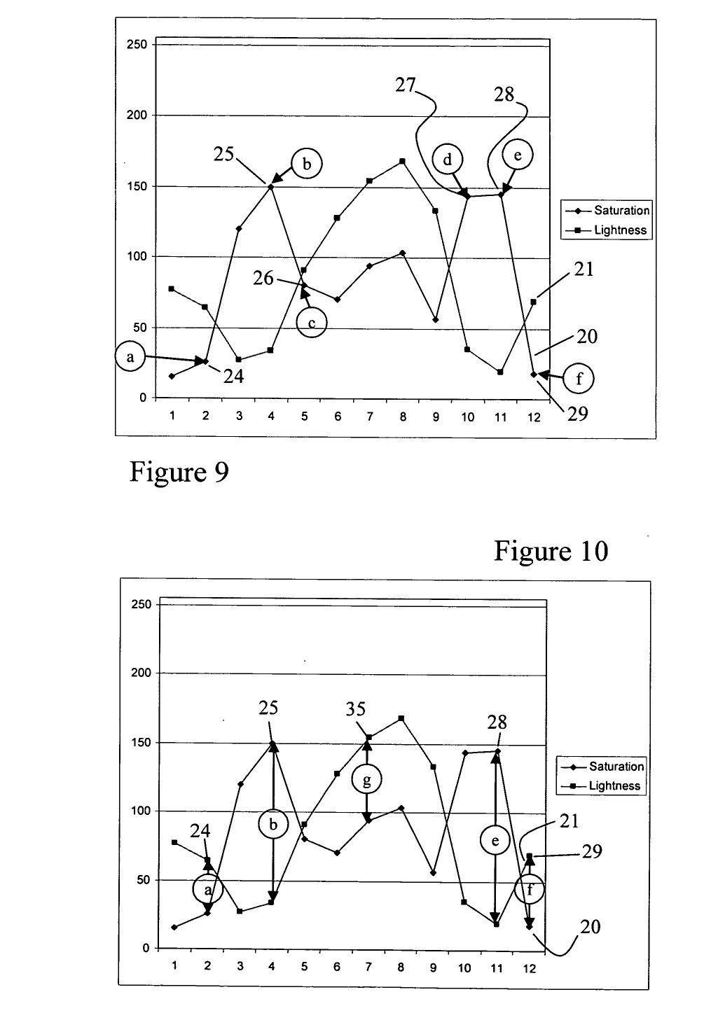

FIG. 9 is a graph showing points of the type 2 feature of FIG. 4 identified by the detection algorithm;

FIG. 10 is a graph showing the comparison between saturation and lightness involved in the detection of the type 2 feature of FIG. 4;

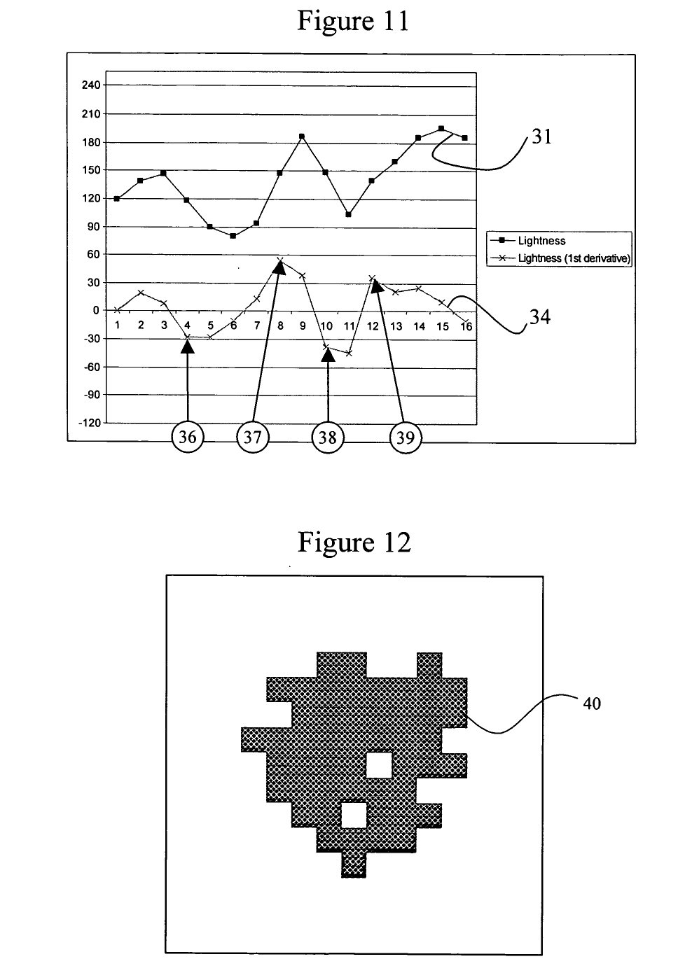

FIG. 11 is a graph showing the lightness and first derivative behaviour of the type 3 feature of FIG. 5;

FIG. 12 is a diagram illustrating an isolated, closed area of pixels forming a feature;

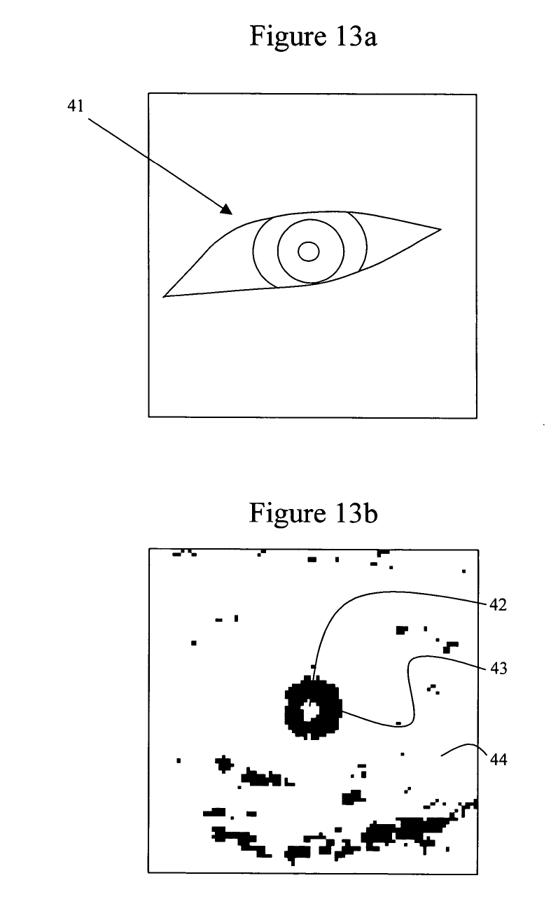

FIG. 13a and FIG. 13b illustrate a technique for red area detection;

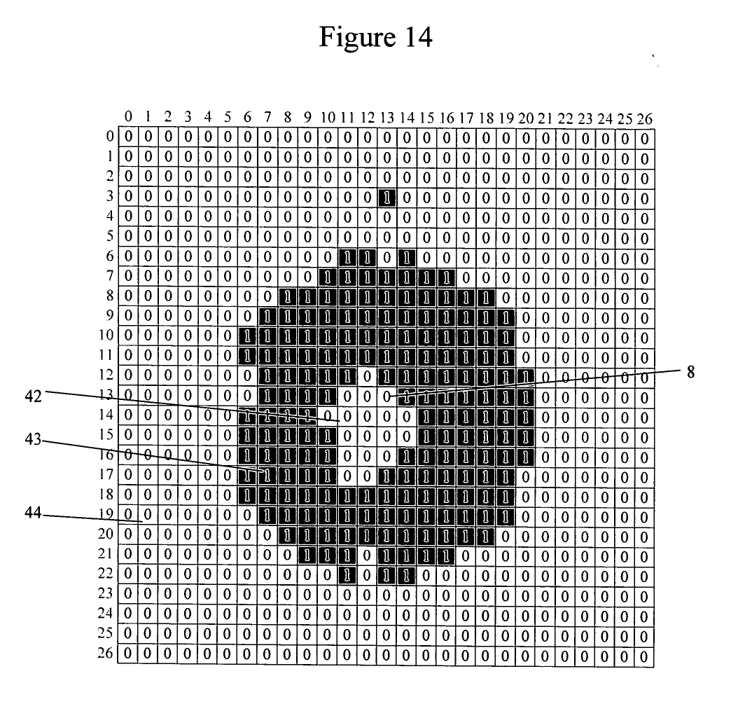

FIG. 14 shows an array of pixels indicating the correctability of pixels in the array;

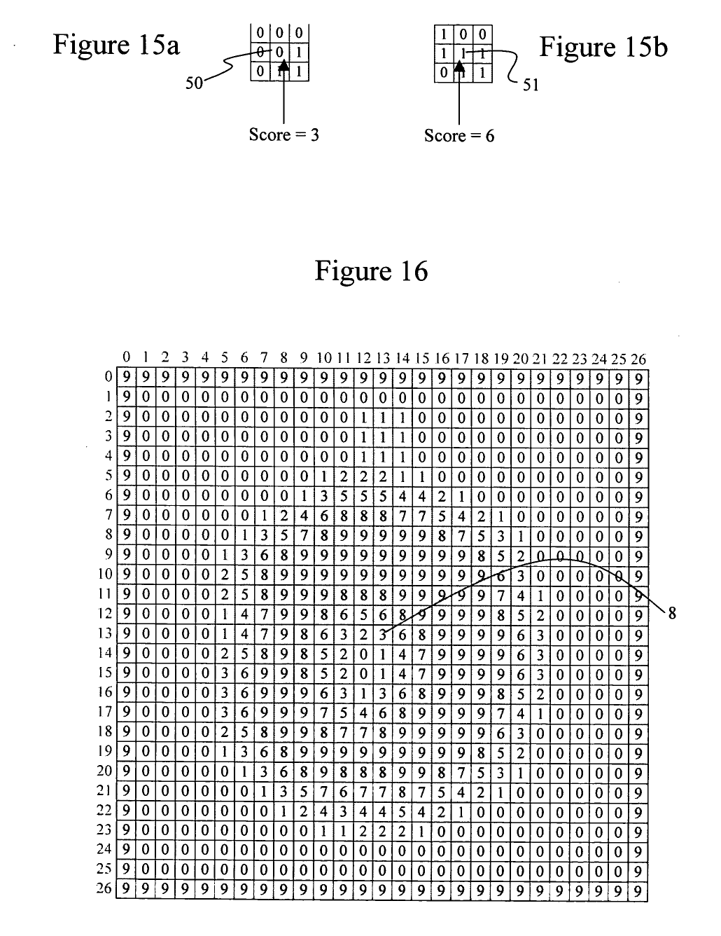

FIGS. 15a and 15b shows a mechanism for scoring pixels in the array of FIG. 14;

FIG. 16 shows an array of scored pixels generated from the array of FIG. 14;

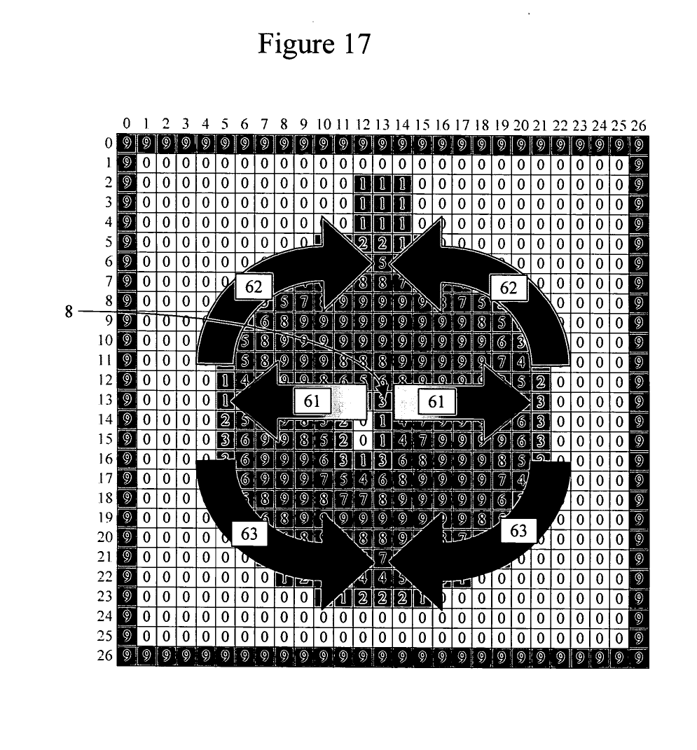

FIG. 17 is a schematic diagram illustrating generally the method used to identify the edges of the correctable area of the array of FIG. 16;

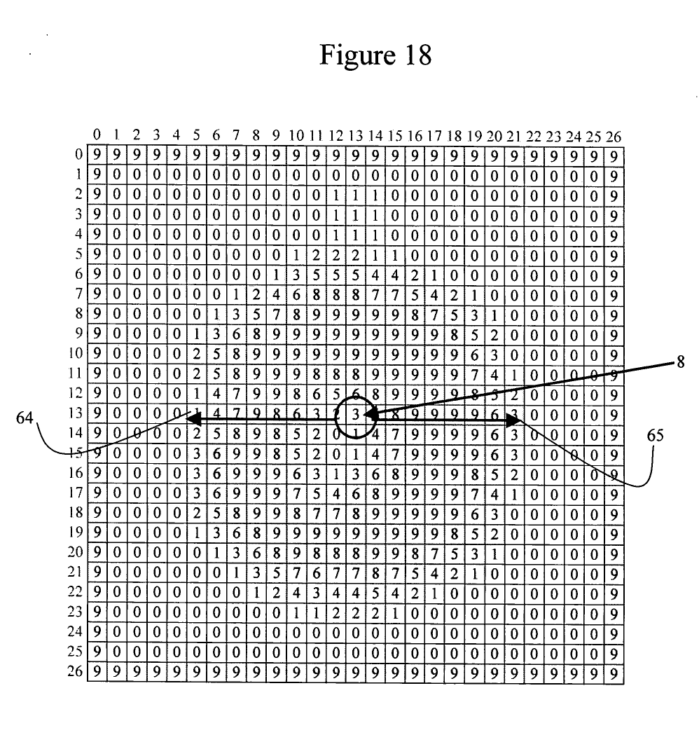

FIG. 18 shows the array of FIG. 16 with the method used to find the edges of the area in one row of pixels;

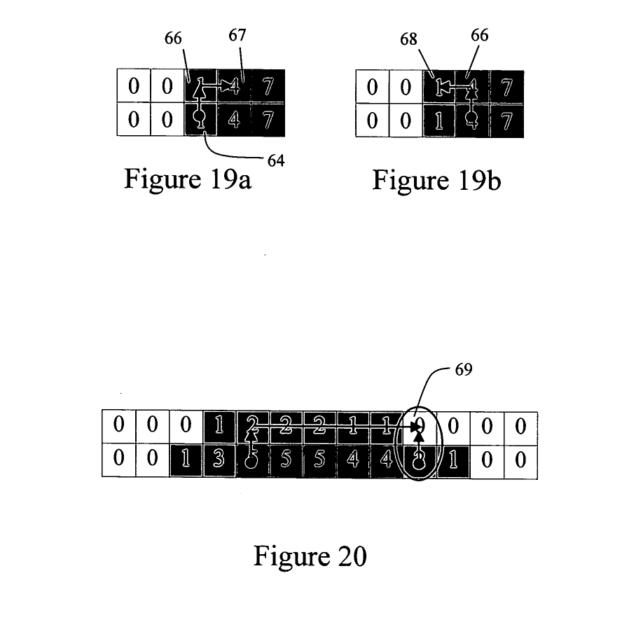

FIGS. 19a and 19b show the method used to follow the edge of correctable pixels upwards;

FIG. 20 shows the method used to find the top edge of a correctable area;

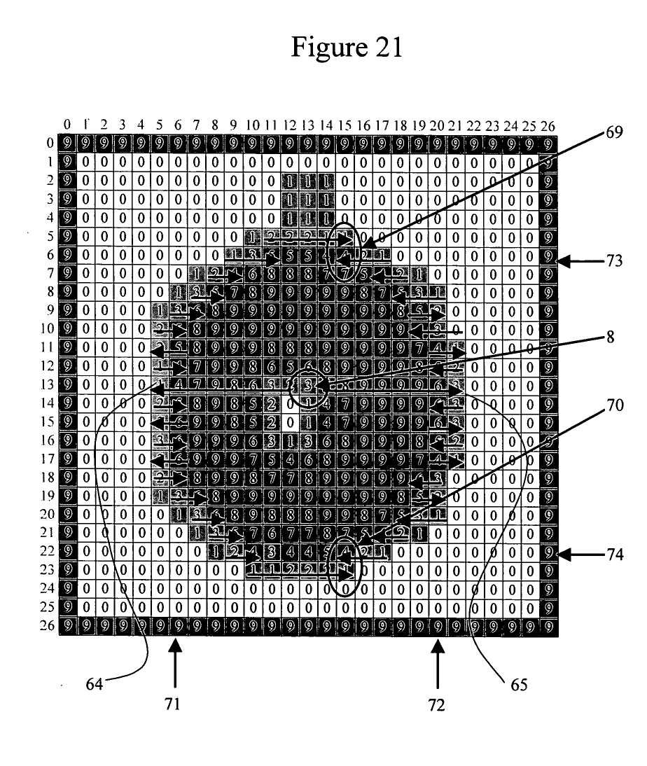

FIG. 21 shows the array of FIG. 16 and illustrates in detail the method used to follow the edge of the correctable area;

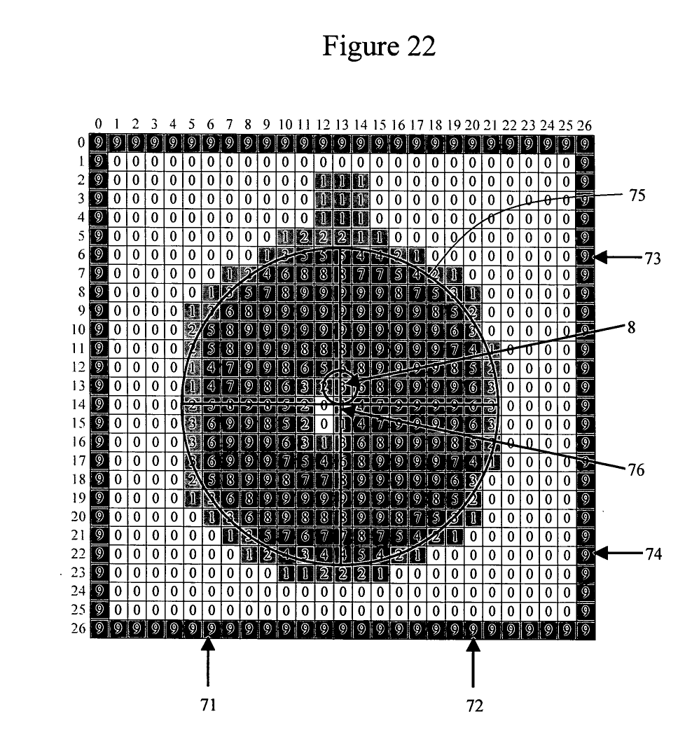

FIG. 22 shows the radius of the correctable area of the array of FIG. 16;

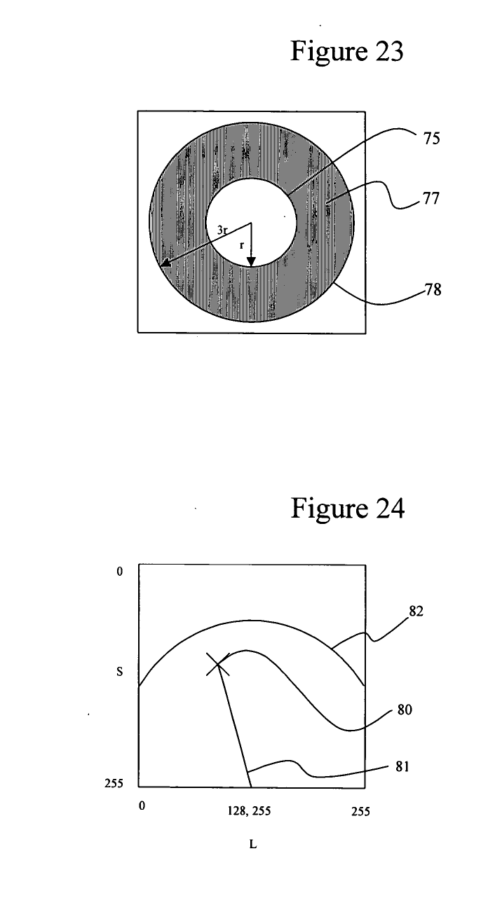

FIG. 23 is a schematic diagram showing the extent of an annulus around the red-eye feature for which further statistics are to be recorded;

FIG. 24 illustrates how a saturation multiplier is calculated by the distance of a pixel's lightness and saturation from (L,S)=(128,255);

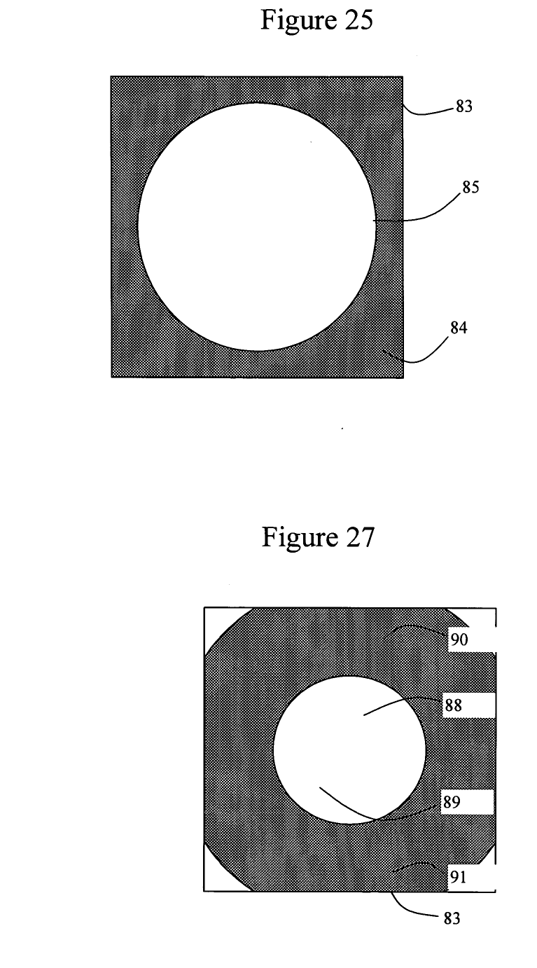

FIG. 25 illustrates an annulus over which the saturation multiplier is radially graduated;

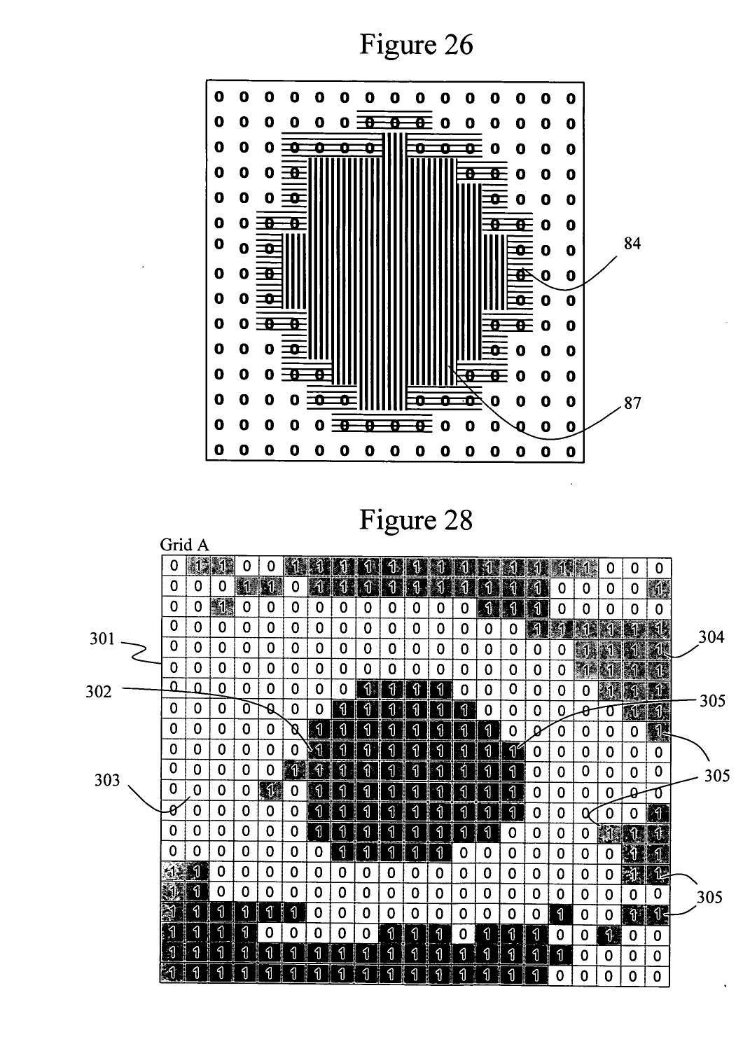

FIG. 26 illustrates the pixels for which the saturation multiplier is smoothed;

FIG. 27 illustrates an annulus over which the lightness multiplier is radially graduated;

FIG. 28 shows the extent of a flared red-eye following correction;

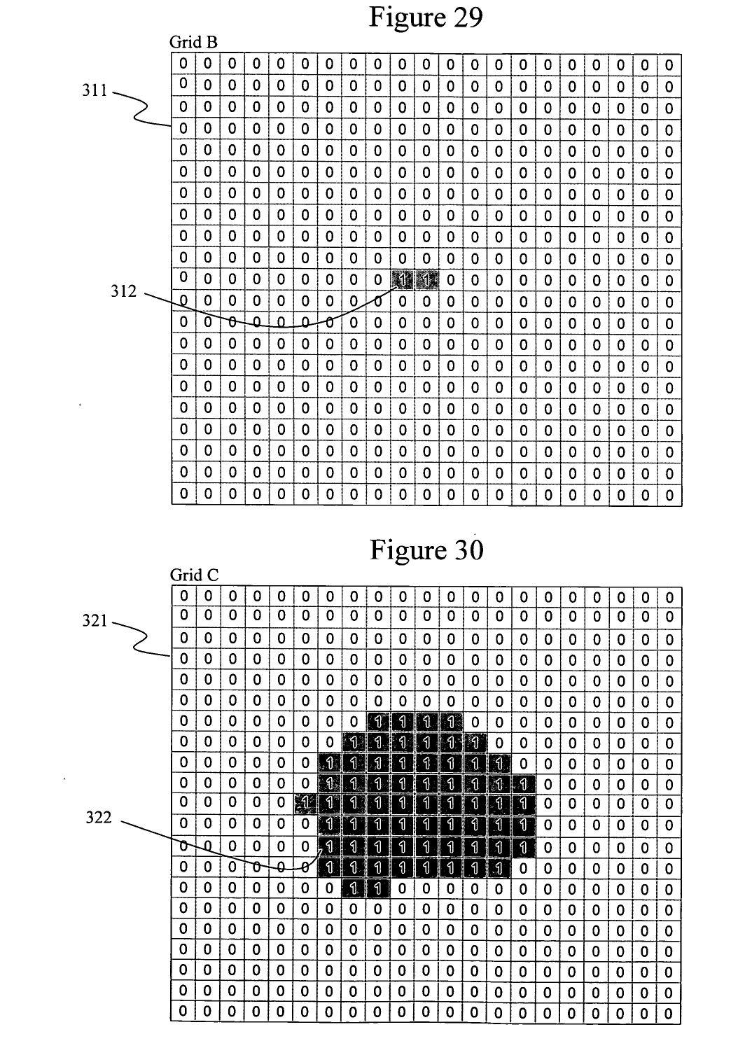

FIG. 29 shows a grid in which the flare pixels identified in FIG. 28 have been reduced to a simulated highlight;

FIG. 30 shows the grid of FIG. 28 showing only pixels with a very low saturation;

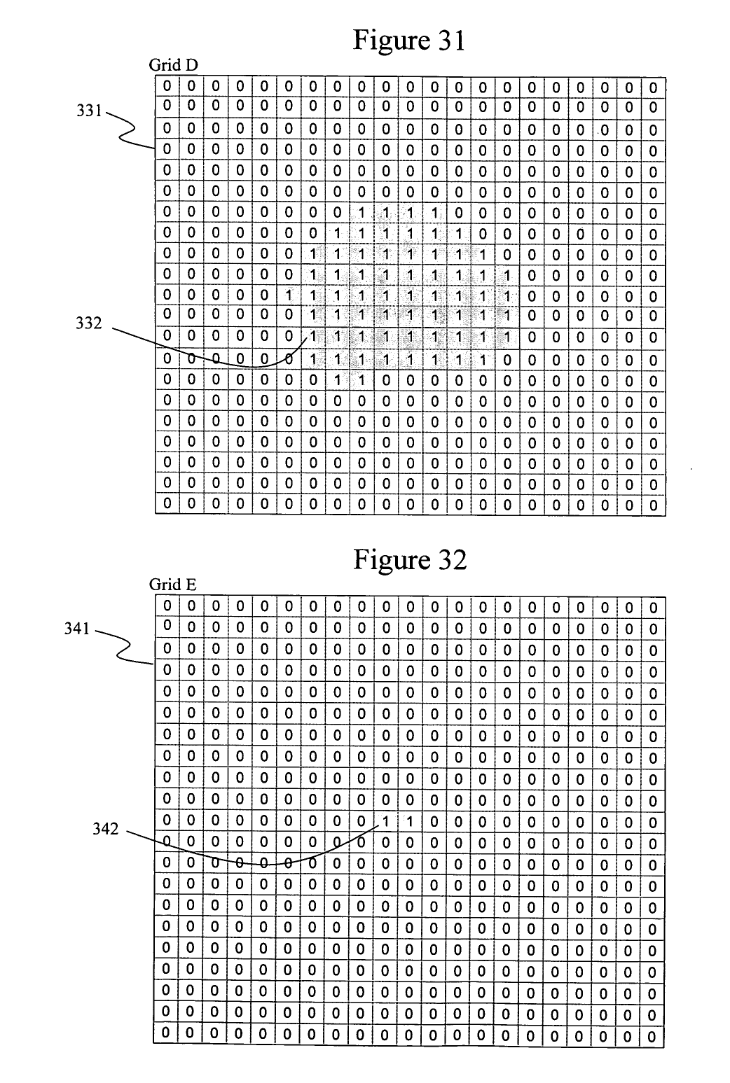

FIG. 31 shows the grid of FIG. 30 following the removal of isolated pixels;

FIG. 32 shows the grid of FIG. 29 following a comparison with FIG. 31;

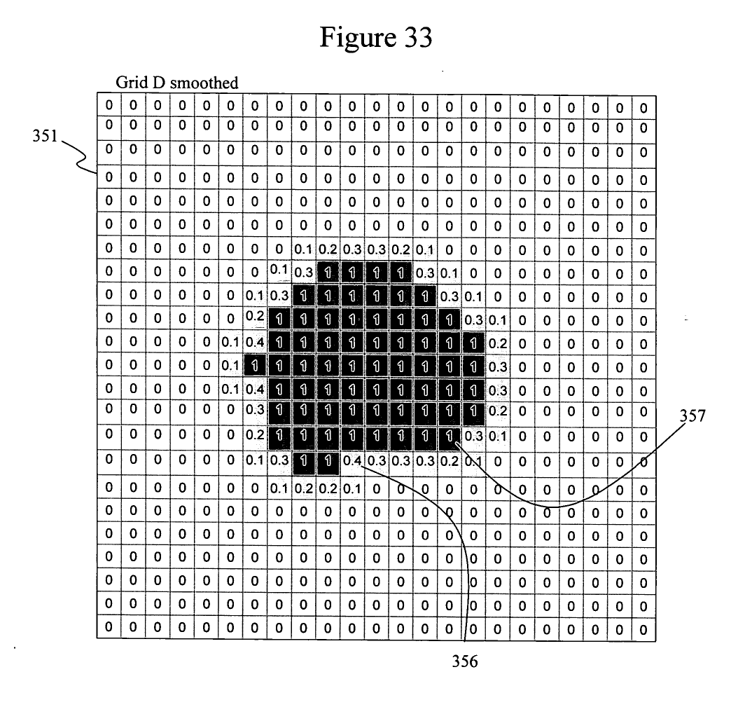

FIG. 33 shows the grid of FIG. 31 following edge smoothing; and

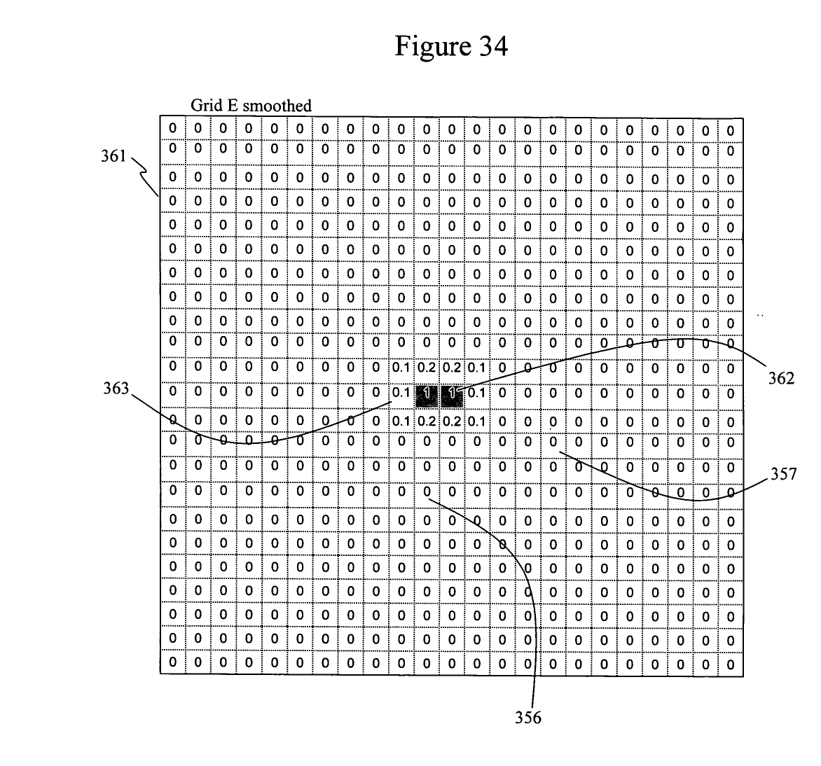

FIG. 34 shows the grid of FIG. 32 following edge smoothing.

A suitable algorithm for processing of a digital image which may or may not contain red-eye features can be broken down into six discrete stages:

1. Scan through each pixel in the image looking for features that occur in red-eyes. This produces a list of features.

2. For each feature, attempt to find an area containing that feature which could describe a red-eye, disregarding features for which this fails. This produces a list of areas.

3. Analyse each of the areas, and calculate statistics and record properties of each area that are used in the next step.

4. Validate each area, applying numerous tests to each area based on its properties and statistics. Use the results of these tests to determine whether to keep the area (if it may be a red-eye) or reject it (if it clearly is not a red-eye).

5. Remove areas that interact in specified ways.

6. Correct those areas that remain, removing the redness and modifying the saturation and lightness to produce a natural looking non-red-eye

These stages are represented as a flow diagram in FIG. 1.

The output from the algorithm is an image where all detected occurrences of red-eye have been corrected. If the image contains no red-eye, the output is an image which looks substantially the same as the input image. It may be that features on the image which resemble red-eye closely are detected and ‘corrected’ by the algorithm, but it is likely that the user will not notice these erroneous ‘corrections’.

The implementation of each of the stages referred to above will now be described in more detail.

Stage 1—Feature Detection

The image is first transformed so that the pixels are represented by Hue (H), Saturation (S) and Lightness (L) values. The entire image is then scanned in horizontal lines, pixel-by-pixel, searching for particular features characteristic of red-eyes. These features are specified by patterns within the saturation, lightness and hue occurring in consecutive adjacent pixels, including patterns in the differences in values between pixels.

FIG. 2 is a schematic diagram showing a typical red-eye feature 1. At the centre of the feature 1 is a white or nearly white “highlight” 2, which is surrounded by a region 3 corresponding to the subject's pupil. In the absence of red-eye, this region 3 would normally be black, but in a red-eye feature this region 3 takes on a reddish hue. This can range from a dull glow to a bright red. Surrounding the pupil region 3 is the iris 4, some or all of which may appear to take on some of the red glow from the pupil region 3.

The appearance of the red-eye feature depends on a number of factors, including the distance of the camera from the subject. This can lead to a certain amount of variation in the form of red-eye feature, and in particular the behaviour of the highlight. In some red-eye features, the highlight is not visible at all. In practice, red-eye features fall into one of five categories:

The first category is designated as “Type 1”. This occurs when the eye exhibiting the red-eye feature is large, as typically found in portraits and close-up pictures. The highlight 2 is at least one pixel wide and is clearly a separate feature to the red pupil 3. The behaviour of saturation and lightness for an exemplary Type 1 feature is shown in FIG. 3.

Type 2 features occur when the eye exhibiting the red-eye feature is small or distant from the camera, as is typically found in group photographs. The highlight 2 is smaller than a pixel, so the red of the pupil mixes with the small area of whiteness in the highlight, turning an area of the pupil pink, which is an unsaturated red. The behaviour of saturation and lightness for an exemplary Type 2 feature is shown in FIG. 4.

Type 3 features occur under similar conditions to Type 2 features, but they are not as saturated. They are typically found in group photographs where the subject is distant from the camera. The behaviour of lightness for an exemplary Type 3 feature is shown in FIG. 5.

Type 4 features occur when the pupil is well dilated, leaving little or no visible iris, or when the alignment of the camera lens, flash and eye are such that a larger than usual amount of light is reflected from the eye. There is no distinct, well-defined highlight, but the entire pupil has a high lightness. The hue may be fairly uniform over the pupil, or it may vary substantially, so that such an eye may look quite complex and contain a lot of detail. Such an eye is known as a “flared” red-eye, or “flare”. The behaviour of saturation and lightness for an exemplary Type 4 feature is shown in FIG. 6.

Type 5 features occur under similar conditions to Type 4, are not as light or saturated, such as pupils which are a dull red glow, and/or do not contain a highlight. The behaviour inside the feature can vary, but the region immediately outside the feature is more clearly defined. Type 5 features are further categorised into four “sub-categories” of the feature, labelled according to the highest value of saturation and lightness within the feature. The behaviour of saturation and lightness for an exemplary Type 5 feature is shown in FIG. 7.

Although it is possible to search for all types of feature in one scan, it is computationally simpler to scan the image in multiple phases. Each phase searches for a single, distinct type of feature, apart from the final phase which simultaneously detects all of the Type 5 sub-categories.

Type 1 Features

Most of the pixels in the highlight of a Type 1 feature have a very high saturation, and it is unusual to find areas this saturated elsewhere on facial pictures. Similarly, most Type 1 features will have high lightness values. FIG. 3 shows the saturation 10 and lightness 11 profile of one row of pixels in an exemplary Type 1 feature. The region in the centre of the profile with high saturation and lightness corresponds to the highlight region 12. The pupil 13 in this example includes a region outside the highlight region 12 in which the pixels have lightness values lower than those of the pixels in the highlight. It is also important to note that not only will the saturation and lightness values of the highlight region 12 be high, but also that they will be significantly higher than those of the regions immediately surrounding them. The change in saturation from the pupil region 13 to the highlight region 12 is very abrupt.

The Type 1 feature detection algorithm scans each row of pixels in the image, looking for small areas of light, highly saturated pixels. During the scan, each pixel is compared with its preceding neighbour (the pixel to its left). The algorithm searches for an abrupt increase in saturation and lightness, marking the start of a highlight, as it scans from the beginning of the row. This is known as a “rising edge”. Once a rising edge has been identified, that pixel and the following pixels (assuming they have a similarly high saturation and lightness) are recorded, until an abrupt drop in saturation is reached, marking the other edge of the highlight. This is known as a “falling edge”. After a falling edge, the algorithm returns to searching for a rising edge marking the start of the next highlight.

A typical algorithm might be arranged so that a rising edge is detected if:

1. The pixel is highly saturated (saturation>128).

2. The pixel is significantly more saturated than the previous one (this pixel's saturation—previous pixel's saturation>64).

3. The pixel has a high lightness value (lightness>128)

4. The pixel has a “red” hue (210≦hue≦255 or 0≦hue≦10).

The rising edge is located on the pixel being examined. A falling edge is detected if:

the pixel is significantly less saturated than the previous one (previous pixel's saturation—this pixel's saturation>64).

The falling edge is located on the pixel preceding the one being examined.

An additional check is performed while searching for the falling edge. After a defined number of pixels (for example 10) have been examined without finding a falling edge, the algorithm gives up looking for the falling edge. The assumption is that there is a maximum size that a highlight in a red-eye feature can be—obviously this will vary depending on the size of the picture and the nature of its contents (for example, highlights will be smaller in group photos than individual portraits at the same resolution). The algorithm may determine the maximum highlight width dynamically, based on the size of the picture and the proportion of that size which is likely to be taken up by a highlight (typically between 0.25% and 1% of the picture's largest dimension).

If a highlight is successfully detected, the co-ordinates of the rising edge, falling edge and the central pixel are recorded.

The algorithm is as follows:

```
for each row in the bitmap
        looking for rising edge = true
        loop from 2^{nd} pixel to last pixel
                if looking for rising edge
                        if saturation of this pixel > 128 and...
                        ...this pixel's saturation − previous pixel's saturation > 64 and...
                        ...lightness of this pixel > 128 and...
                        ...hue of this pixel ≧ 210 or ≦ 10 then
                                rising edge = this pixel
                                looking for rising edge = false
                        end if
                else
                        if previous pixel's saturation-this pixel's saturation > 64 then
                                record position of rising edge
                                record position of falling edge (previous pixel)
                                record position of centre pixel
                                looking for rising edge = true
                        end if
                end if
                if looking for rising edge = false and ...
                ...rising edge was detected more than 10 pixels ago
                        looking for rising edge = true
                end if
        end loop
end for
```

The result of this algorithm on the red-eye feature 1 is shown in FIG. 8. For this feature, since there is a single highlight 2, the algorithm will record one rising edge 6, one falling edge 7 and one centre pixel 8 for each row the highlight covers. The highlight 2 covers five rows, so five central pixels 8 are recorded. In FIG. 8, horizontal lines stretch from the pixel at the rising edge to the pixel at the falling edge. Circles show the location of the central pixels 8.

Following the detection of Type 1 features and the identification of the central pixel in each row of the feature, the detection algorithm moves on to Type 2 features.

Type 2 Features

Type 2 features cannot be detected without using features of the pupil to help. FIG. 4 shows the saturation 20 and lightness 21 profile of one row of pixels of an exemplary Type 2 feature. The feature has a very distinctive pattern in the saturation and lightness channels, which gives the graph an appearance similar to interleaved sine and cosine waves.

The extent of the pupil 23 is readily discerned from the saturation curve, the red pupil being more saturated than its surroundings. The effect of the white highlight 22 on the saturation is also evident: the highlight is visible as a peak 22 in the lightness curve, with a corresponding drop in saturation. This is because the highlight is not white, but pink, and pink does not have high saturation. The pinkness occurs because the highlight 22 is smaller than one pixel, so the small amount of white is mixed with the surrounding red to give pink.

Another detail worth noting is the rise in lightness that occurs at the extremities of the pupil 23. This is due more to the darkness of the pupil than the lightness of its surroundings. It is, however, a distinctive characteristic of this type of red-eye feature.

The detection of a Type 2 feature is performed in two phases. First, the pupil is identified using the saturation channel. Then the lightness channel is checked for confirmation that it could be part of a red-eye feature. Each row of pixels is scanned as for a Type 1 feature, with a search being made for a set of pixels satisfying certain saturation conditions. FIG. 9 shows the saturation 20 and lightness 21 profile of the red-eye feature illustrated in FIG. 4, together with detectable pixels ‘a’ 24, ‘b’ 25, ‘c’ 26, ‘d’ 27, ‘e’ 28, ‘f’ 29 on the saturation curve 20.

The first feature to be identified is the fall in saturation between pixel ‘b’ 25 and pixel ‘c’ 26. The algorithm searches for an adjacent pair of pixels in which one pixel 25 has saturation ≧100 and the following pixel 26 has a lower saturation than the first pixel 25. This is not very computationally demanding because it involves two adjacent points and a simple comparison. Pixel ‘c’ is defined as the pixel 26 further to the right with the lower saturation. Having established the location 26 of pixel ‘c’, the position of pixel ‘b’ is known implicitly—it is the pixel 25 preceding ‘c’.

Pixel ‘b’ is the more important of the two—it is the first peak in the saturation curve, where a corresponding trough in lightness should be found if the highlight is part of a red-eye feature.

The algorithm then traverses left from ‘b’ 25 to ensure that the saturation value falls continuously until a pixel 24 having a saturation value of ≦50 is encountered. If this is the case, the first pixel 24 having such a saturation is designated ‘a’. Pixel ‘f’ is then found by traversing rightwards from ‘c’ 26 until a pixel 29 with a lower saturation than ‘a’ 24 is found. The extent of the red-eye feature is now known.

The algorithm then traverses leftwards along the row from ‘f’ 29 until a pixel 28 is found with higher saturation than its left-hand neighbour 27. The left hand neighbour 27 is designated pixel ‘d’ and the higher saturation pixel 28 is designated pixel ‘e’. Pixel ‘d’ is similar to ‘c’; its only purpose is to locate a peak in saturation, pixel ‘e’.

A final check is made to ensure that the pixels between ‘b’ and ‘e’ all have lower saturation than the highest peak.

It will be appreciated that if any of the conditions above are not fulfilled then the algorithm will determine that it has not found a Type 2 feature and return to scanning the row for the next pair of pixels which could correspond to pixels ‘b’ and ‘c’ of a Type 2 feature. The conditions above can be summarised as follows:

| Range | Condition |
|---|---|
| bc | Saturation(c) < Saturation(b) and Saturation(b) ≧ 100 |
| ab | Saturation has been continuously rising from a to b and |
| | Saturation(a) ≦ 50 |
| af | Saturation(f) ≦ Saturation(a) |
| ed | Saturation(d) < Saturation(e) |
| be | All Saturation(b..e) ≦ max(Saturation(b), Saturation(e)) |

If all the conditions are met, a feature similar to the saturation curve in FIG. 9 has been detected. The detection algorithm then compares the saturation with the lightness of pixels ‘a’ 24, ‘b’ 25, ‘e’ 28 and ‘f’ 29, as shown in FIG. 10, together with the centre pixel 35 of the feature defined as pixel ‘g’ half way between ‘a’ 24 and ‘f’ 29. The hue of pixel ‘g’ is also a consideration. If the feature corresponds to a Type 2 feature, the following conditions must be satisfied:

| Pixel | Description | Condition |
|---|---|---|
| ‘a’ 24 | Feature start | Lightness > Saturation |
| ‘b’ 25 | First peak | Saturation > Lightness |
| ‘g’ 35 | Centre | Lightness > Saturation and Lightness ≧ 100, and: |
| | | 220 ≦ Hue ≦ 255 or 0 ≦ Hue ≦ 10 |
| ‘e’ 28 | Second peak | Saturation > Lightness |
| ‘f’ 27 | Feature end | Lightness > Saturation |

It will be noted that the hue channel is used for the first time here. The hue of the pixel 35 at the centre of the feature must be somewhere in the red area of the spectrum. This pixel will also have a relatively high lightness and mid to low saturation, making it pink—the colour of highlight that the algorithm sets out to identify.

Once it is established that the row of pixels matches the profile of a Type 2 feature, the centre pixel 35 is identified as the centre point 8 of the feature for that row of pixels as shown in FIG. 8, in a similar manner to the identification of centre points for Type 1 features described above.

Type 3 Features

The detection algorithm then moves on to Type 3 features. FIG. 5 shows the lightness profile 31 of a row of pixels for an exemplary Type 3 highlight 32 located roughly in the centre of the pupil 33. The highlight will not always be central: the highlight could be offset in either direction, but the size of the offset will typically be quite small (perhaps ten pixels at the most), because the feature itself is never very large.

Type 3 features are based around a very general characteristic of red-eyes, visible also in the Type 1 and Type 2 features shown in FIGS. 3 and 4. This is the ‘W’ shaped curve in the lightness channel 31, where the central peak is the highlight 12, 22, 32, and the two troughs correspond roughly to the extremities of the pupil 13, 23, 33. This type of feature is simple to detect, but it occurs with high frequency in many images, and most occurrences are not caused by red-eye.

The method for detecting Type 3 features is simpler and quicker than that used to find Type 2 features. The feature is identified by detecting the characteristic ‘W’ shape in the lightness curve 31. This is performed by examining the discrete analogue 34 of the first derivative of the lightness, as shown in FIG. 11. Each point on this curve is determined by subtracting the lightness of the pixel immediately to the left of the current pixel from that of the current pixel.

The algorithm searches along the row examining the first derivative (difference) points. Rather than analyse each point individually, the algorithm requires that pixels are found in the following order satisfying the following four conditions:

| Pixel | Condition |
|---|---|
| First 36 | Difference ≦ −20 |
| Second 37 | Difference ≧ 30 |
| Third 38 | Difference ≦ −30 |
| Fourth 39 | Difference ≧ 20 |

There is no constraint that pixels satisfying these conditions must be adjacent. In other words, the algorithm searches for a pixel 36 with a difference value of −20 or lower, followed eventually by a pixel 37 with a difference value of at least 30, followed by a pixel 38 with a difference value of −30 or lower, followed by a pixel 39 with value of at least 20. There is a maximum permissible length for the pattern—in one example it must be no longer than 40 pixels, although this is a function of the image size and any other pertinent factors.

An additional condition is that there must be two ‘large’ changes (at least one positive and at least one negative) in the saturation channel between the first 36 and last 39 pixels. A ‘large’ change may be defined as ≧30.

Finally, the central point (the one half-way between the first 36 and last 39 pixels in FIG. 11) must have a “red” hue in the range 220≦Hue≦255 or 0≦Hue≦10.

The central pixel 8 as shown in FIG. 8 is defined as the central point midway between the first 36 and last 39 pixels.

Type 4 Features

These eyes have no highlight within or abutting the red-eye region, so the characteristics of a highlight cannot be used to detect them. However, such eyes are characterised by having a high saturation within the pupil region. FIG. 6 shows the pixel saturation 100 and lightness 101 data from a single row in such an eye.

The preferred method of detection is to scan through the image looking for a pixel 102 with saturation above some threshold, for example 100. If this pixel 102 marks the edge of a red-eye feature, it will have a hue in the appropriate range of reds, i.e. above 210 or less than 20. The algorithm will check this. It will further check that the saturation exceeds the lightness at this point, as this is also characteristic of this type of red-eye.

The algorithm will then scan left from the high saturation pixel 102, to determine the approximate beginning of the saturation rise. This is done by searching for the first significant minimum in saturation to the left of the high saturation pixel 102. Because the saturation fall may not be monotonic, but may include small oscillations, this scan should continue to look a little further—e.g. 3 pixels—to the left of the first local minimum it finds, and then designate the pixel 103 having the lowest saturation found as marking the feature's beginning.

The algorithm will then scan right from the high saturation pixel 102, seeking a significant minimum 104 in saturation that marks the end of the feature. Again, because the saturation may not decrease monotonically from its peak but may include irrelevant local minima, some sophistication is required at this stage. The preferred implementation will include an algorithm such as the following to accomplish this:

```
loop right through pixels from first highly saturated pixel until
                . . . NoOfTries > 4 OR at end of row OR
                gone 40 pixels right
        if sat rises between this and next pixel
                record sat here
                increment NoOfTries
                loop right three more pixels
                        if not beyond row end
                                if (sat >= 200) OR
                                (recorded sat − sat > 10)
                                        set StillHighOrFalling
                                        flag
                                        record this pixel
                                end if
                        else
                                set EdgeReached flag
                        end if
                end loop
                if NOT EdgeReached
                        if StillHighOrFalling
                                go back to outer loop and try the
                                pixel where
                                . . . stillHighOrFalling was set
                        else
                                set FoundEndOfSatDrop flag
                                record this pixel as the end of the
                                sat drop
                        end if
                end if
        end if
end loop
```

This algorithm is hereafter referred to as the SignificantMinimum algorithm. It will be readily observed that it may identify a pseudo-minimum, which is not actually a local minimum.

If the FoundEndOfSatDrop flag is set, the algorithm has found a significant saturation minimum 104. If not, it has failed, and this is not a type 4 feature. The criteria for a “significant saturation minimum” are that:

1. A pixel has no pixels within three to its right with saturation more than 200.

2. The saturation does not drop substantially (e.g. by more than a value of 10) within three pixels to the right.

3. No more than four local minima in saturation occur between the first highly saturated pixel 102 and this pixel.

The left 103 and right 104 saturation pseudo-minima found above correspond to the left and right edges of the feature, and the algorithm has now located a region of high saturation. Such regions occur with high frequency in many images, and many are not associated with red-eyes. In order to further refine the detection process, therefore, additional characteristics of flared red-eyes are used. For this purpose, the preferred implementation will use the lightness across this region. If the feature is indeed caused by red-eye, the lightness curve will again form a ‘W’ shape, with two substantial trough-like regions sandwiching a single peak between them.

The preferred implementation will scan between the left and right edges of the feature and ensure that there are at least two local lightness minima 105, 106 (pixels whose left and right neighbours both have higher lightness). If so, there is necessarily at least one local maximum 107. The algorithm also checks that both of these minima 105, 106 occur on pixels where the saturation value is higher than the lightness value. Further, it will check that the lowest lightness between the two lightness minima is not lower than the smaller of the two lightness minima 105, 106—i.e. the pixel with the lowest lightness between the lightness minima 105, 106 must be one of the two local lightness minima 105,106.

The lightness in a red-eye rises to a fairly high value, so the preferred implementation requires that, somewhere between the left 105 and right 106 lightness minima, the lightness rises above some threshold, e.g. 128. In addition, it is characteristic of flared red-eyes that the lightness and saturation curves cross, typically just inside the outer minima of saturation 103, 104 that define the feature width. The preferred implementation checks that the lightness and saturation do indeed cross. Also, the difference between the lightness and saturation curves must exceed 50 at some point within the feature. If all the required criteria are satisfied, the algorithm records the detected feature as a Type 4 detection.

The Type 4 detection criteria can be summarised as follows:

High saturation pixel 102 found with saturation>100.

High saturation pixel has 210≦Hue≦255 or 0≦Hue≦20.

Local saturation minima 103, 104 found each side of high saturation pixel and used to mark edges of feature.

Saturation and lightness cross twice between edges of feature 103, 104.

At least one pixel between edges of feature 103, 104 has Saturation—Lightness>50.

Two local lightness minima 105, 106 found between edges of feature 103, 104.

Saturation>lightness for each local lightness minimum.

Lowest lightness between lightness minima 105, 106 found at one of local lightness minima 105, 106.

At least one pixel between lightness minima 105, 106 has lightness>128

The central pixel 8 as shown in FIG. 8 is defined as the central point midway between the pixels 103, 104 marking the edge of the feature.

Type 5 Features

The Type 4 detection algorithm does not detect all flared red-eyes. The Type 5 algorithm is essentially an extension of Type 4 which detects some of the flared red-eyes missed by the Type 4 detection algorithm. FIG. 7 shows the pixel saturation 200 and lightness 201 data for a typical Type 5 feature.

The preferred implementation of the Type 5 detection algorithm commences by scanning through the image looking for a first saturation threshold pixel 202 with saturation above some threshold, e.g. 100. Once such a pixel 202 is found, the algorithm scans to the right until the saturation drops below this saturation threshold and identifies the second saturation threshold pixel 203 as the last pixel before this happens. As it does so, it will record the saturation maximum pixel 204 with highest saturation. The feature is classified on the basis of this highest saturation: if it exceeds some further threshold, e.g. 200, the feature is classed as a “high saturation” type 5. If not, it is classed as “low saturation”.

The algorithm then searches for the limits of the feature, defined as the first significant saturation minima 205, 206 outside the set of pixels having a saturation above the threshold. These minima are found using the SignificantMinimum algorithm described above with reference to Type 4 searching. The algorithm scans left from the first threshold pixel 202 to find the left hand edge 205, and then right from the second threshold pixel 203 to find the right hand edge 206.

The algorithm then scans right from the left hand edge 205 comparing the lightness and saturation of pixels, to identify a first crossing pixel 207 where the lightness first drops below the saturation. This must occur before the saturation maximum pixel 204 is reached. This is repeated scanning left from the right hand edge 206 to find a second crossing pixel 208, which marks the pixel before lightness crosses back above saturation immediately before the right hand edge 206.

It will be noted that, for the feature shown in FIG. 7, the first crossing pixel 207 and the first threshold pixel 202 are the same pixel. It will be appreciated that this is a con-incidence which has no effect on the further operation of the algorithm.

The algorithm now scans from the first crossing pixel 207 to the second crossing pixel 208, ensuring that saturation>lightness for all pixels between the two. While it is doing this, it will record the highest value of lightness (LightMax), found at a lightness maximum pixel 209, and the lowest value of lightness (LightMin) occurring in this range. The feature is classified on the basis of this maximum lightness: if it exceeds some threshold, e.g. 100, the feature is classed as “high lightness”. Otherwise it is classed as “low lightness”.

The characteristics so far identified essentially correspond to those required by the type 4 detection algorithm. Another such similarity is the ‘W’ shape in the lightness curve, also required by the type 5 detection algorithm. The algorithm scans right from the left hand edge 205 to the right hand edge 206 of the feature, seeking a first local minimum 210 in lightness. This will be located even if the minimum is more than one pixel wide, but no more than three pixels wide. The local lightness minimum pixel 210 will be the leftmost pixel in the case of a minimum more than a single pixel wide. The algorithm then scans left from the right hand edge 206 as far as the left hand edge 205 to find a second local lightness minimum pixel 211. This, again, will be located if the minimum is one, two or three (but not more then three) pixels wide.

At this point, type 5 detection diverges from type 4 detection. The algorithm scans four pixels to the left of the first local lightness minimum 210 to check that the lightness does not fall below its value at that minimum. The algorithm similarly scans four pixels to the right of the second local lightness minimum 211 to check that the lightness does not fall below its value at that minimum..

If the feature has been determined to be a “low lightness” type 5, the difference between LightMax and LightMin is checked to ensure that it does not exceed some threshold, e.g. 50.

If the feature is “low lightness” or “high saturation”, the algorithm checks that the saturation remains above the lightness between the first and second crossing pixels 207, 208. This is simply a way of checking whether the lightness and saturation curves cross more than twice.

If the feature is “high lightness”, the algorithm scans the pixels between the local lightness minima 210, 211 to ensure that the lightness never drops below the lower of the lightness values of the local lightness minima 210, 211. In other words, the minimum lightness between the local lightness minima 210, 211 must be at one of those minima.

The final checks performed by the algorithm concern the saturation threshold pixels 202, 203. The hue of both of these pixels will be checked to ensure that it falls within the correct range of reds, i.e. it must be either below 20 or above 210.

If all of these checks are passed, the algorithm has identified a type 5 feature. This feature is then classified into the appropriate sub-type of type 5 as follows:

| | |
|---|---|
| Type 5 sub- | |
| type | Saturation |

| | | |
|---|---|---|
| classification | High | Low |

| | | | |
|---|---|---|---|
| Light | High | 51 | 52 |
| | Low | 53 | 54 |

These sub-types have differing characteristics, which means that, in the preferred implementation, they will be validated using tests specific to the sub-type, not merely the type. This substantially increases the precision of the validation process for all type 5 features. Since type 5 features that are not associated with red-eyes occur frequently in pictures, it is particularly important that validation is specific and accurate for this type. This requires the precision of having validators specific to each of the sub-types of type 5.

The Type 5 detection criteria can be summarised as follows:

Region found having saturation>100.

Pixels at edge of high saturation region have 210≦Hue≦20

Classified as “high saturation” if max saturation>200.

Local saturation minima 205, 206 found each side of high saturation region and used to mark edges of feature.

Two crossing pixels 207, 208, where lightness and saturation cross, located inside edges of feature 205, 206 and either side of maximum saturation pixel 204.

Saturation>lightness for all pixels between the crossing pixels 207, 208.

Classified as “high lightness” if maximum lightness between crossing pixels>100.

Two local lightness minima 210, 211 found between edges of feature 205, 206.

No pixels up to four outside local lightness minima 210, 211 have lower lightness than the corresponding minimum.

If “low lightness”, difference between maximum lightness and minimum lightness between crossing pixels≧50

If “high lightness”, lowest lightness between local lightness minima 210, 211 found at one of local lightness minima 210, 211.

The central pixel 8 as shown in FIG. 8 is defined as the central point midway between the pixels 205, 206 marking the edge of the feature

The location of all of the central pixels 8 for all of the Type 1, Type 2, Type 3, Type 4 and Type 5 features detected are recorded into a list of features which may potentially be caused by red-eye. The number of central pixels 8 in each feature is then reduced to one. As shown in FIG. 8 (with reference to a Type 1 feature), there is a central pixel 8 for each row covered by the highlight 2. This effectively means that the feature has been detected five times, and will therefore need more processing than is really necessary.

Furthermore, not all of the features identified by the algorithms above will necessarily be formed by red-eye features. Others could be formed, for example, by light reflected from corners or edges of objects. The next stage of the process therefore attempts to eliminate such features from the list, so that red-eye reduction is not performed on features which are not actually red-eye features.

There are a number of criteria which can be applied to recognise red-eye features as opposed to false features. One is to check for long strings of central pixels in narrow features—i.e. features which are essentially linear in shape. These may be formed by light reflecting off edges, for example, but will never be formed by red-eye.

This check for long strings of pixels may be combined with the reduction of central pixels to one. An algorithm which performs both these operations simultaneously may search through features identifying “strings” or “chains” of central pixels. If the aspect ratio, which is defined as the length of the string of central pixels 8 (see FIG. 8) divided by the largest feature width of the highlight or feature, is greater than a predetermined number, and the string is above a predetermined length, then all of the central pixels 8 are removed from the list of features. Otherwise only the central pixel of the string is retained in the list of features. It should be noted that these tasks are performed for each feature type individually i.e. searches are made for vertical chains of one type of feature, rather than for vertical chains including different types of features.

In other words, the algorithm performs two tasks:

removes roughly vertical chains of one type of feature from the list of features, where the aspect ratio of the chain is greater than a predefined value, and

removes all but the vertically central feature from roughly vertical chains of features where the aspect ratio of the chain is less than or equal to a pre-defined value.

An algorithm which performs this combination of tasks is given below:

```
for each feature
        (the first section deals with determining the extent of the chain of
        features - if any - starting at this one)
        make ‘current feature’ and ‘upper feature’ = this feature
        make ‘widest radius’ = the radius of this feature
        loop
                search the other features of the same type for one where: y co-
                ordinate = current feature's y co-ordinate + 1; and x co-ordinate
                = current feature's x co-ordinate (with a tolerance of ±1)
                if an appropriate match is found
                        make ‘current feature’ = the match
                        if the radius of the match > ‘widest radius’
                                make ‘widest radius’ = the radius of the match
                        end if
                end if
        until no match is found
        (at this point, ‘current feature’ is the lower feature in the chain
        beginning at ‘upper feature’, so in this section, if the chain is
        linear, it will be removed; if it is roughly circular, all but the
        central feature will be removed)
        make ‘chain height’ = current feature's y co-ordinate − top feature's y
        co-ordinate
        make ‘chain aspect ratio’ = ‘chain height’ / ‘widest radius’
        if ‘chain height’ >= ‘minimum chain height’ and ‘chain aspect ratio’ >
        ‘minimum chain aspect ratio’
        remove all features in the chain from the list of features
        else
                if ‘chain height’ > 1
                        remove all but the vertically central feature in the chain
                        from the list of features
                end if
        end if
end for
```

A suitable threshold for ‘minimum chain height’ is three and a suitable threshold for ‘minimum chain aspect ratio’ is also three, although it will be appreciated that these can be changed to suit the requirements of particular images.

At the end of the Feature Detection process a list of features is recorded. Each feature is categorised as Type 1, 2, 3, 4, 51, 52, 53 or 54, and has associated therewith a reference pixel marking the location of the feature.

Stage 2—Area Detection

For each feature detected in the image, the algorithm attempts to find an associated area that may describe a red-eye. A very general definition of a red-eye feature is an isolated, roughly circular area of “reddish” pixels. It is therefore necessary to determine the presence and extent of the “red” area surrounding the reference pixel identified for each feature. It should be borne in mind that the reference pixel is not necessarily at the centre of the red area. Further considerations are that there may be no red area, or that there may be no detectable boundaries to the red area because it is part of a larger feature—either of these conditions meaning that an area will not be associated with that feature.

The area detection is performed by constructing a rectangular grid whose size is determined by some attribute of the feature, placing it over the feature, and marking those pixels which satisfy some criteria for Hue (H), Lightness (L) and Saturation (S) that are characteristic of red eyes.

The size of the grid is calculated to ensure that it will be large enough to contain any associated red eye: this is possible because in red-eyes the size of the pattern used to detect the feature in the first place will bear some simple relationship to the size of the red eye area.

This area detection is attempted up to three times for each feature, each time using different criteria for H, L and S values. This is because there are essentially three different sets of H, L and S that may be taken as characteristic of red-eyes. These criteria are referred to as HLS, HaLS and Sat128. The criteria are as follows:

| Category | Hue | Saturation | Lightness |
|---|---|---|---|
| HLS | 220 ≦ H OR H ≦ 10 | S ≧ 80 | L < 200 |
| HaLS | — | S = 255 | L > 150 |
| HaLS | 245 ≦ H OR H ≦ 20 | S > 50 AND | L > 100 |
| | | S < (1.8 * L) − 92 AND | |
| | | S > (1.1 * L) − 90 | |
| Sat128 | 220 ≦ H OR H ≦ 10 | 128 ≦ S | — |

If a pixel satisfies either of the two sets of conditions for HaLS, it is classed as HaLS correctable. The relationship between the feature type and which of these categories the algorithm will attempt to use to detect an area is shown in the table below.

| Type | Criteria |
|---|---|
| 1 | HLS, Sat128 |
| 2 | HLS, Sat128 |
| 3 | HLS, Sat128 |
| 4 | HLS, HaLS, Sat128 |
| 5 | HLS |

For each attempt at area detection, the algorithm searches for a region of adjacent pixels satisfying the criteria (hereafter called ‘correctable pixels’). The region must be wholly contained by the bounding rectangle (the grid) and completely bounded by non-correctable pixels. The algorithm thus seeks an ‘island’ of correctable pixels fully bordered by non-correctable pixels which wholly fits within the bounding rectangle. FIG. 12 shows such an isolated area of correctable pixels 40.

Beginning at the reference pixel of the feature, the algorithm checks if the pixel is “correctable” according to the criteria above and, if it does not, moves left one pixel. This is repeated until a correctable pixel is found, unless the edge of the bounding rectangle is reached first. If the edge is reached, the algorithm marks this feature as having no associated area (for this category). If a correctable pixel is found, the algorithm determines, beginning from that pixel, whether that pixel lies within a defined, isolated region of correctable pixels that is wholly contained within the grid encompassing an area around that pixel.

There exist numerous known methods for carrying this out, including those algorithms conventionally known as “flood fill” algorithms of both the iterative and the recursive types. A flood fill algorithm will visit every pixel within an area as it fills the area: if it can thus fill the area without visiting any pixel touching the boundary of the grid, the area is isolated for the purposes of the area detection algorithm. The skilled person will readily be able to devise such an algorithm.

This procedure is then repeated looking right from the central pixel of the feature. If there is an area found starting left of the central pixel and also an area found starting right, the one starting closest to that central pixel of the feature is selected. In this way, a feature may have no area associated with it for a given correctability category, or it may have one area for that category. It may not have more than one.

A suitable technique for area detection is illustrated with reference to FIG. 13, which also highlights a further problem which should be taken into account. FIG. 13a shows a picture of a Type 1 red-eye feature 41, and FIG. 13b shows a map of the correctable 43 and non-correctable 44 pixels in that feature according to the HLS criteria described above.

FIG. 13b clearly shows a roughly circular area of correctable pixels 43 surrounding the highlight 42. There is a substantial ‘hole’ of non-correctable pixels inside the highlight area 42, so the algorithm that detects the area must be able to cope with this.

There are four phases in the determination of the presence and extent of the correctable area:

1. Determine correctability of pixels surrounding the starting pixel.

2. Allocate a notional score or weighting to all pixels

3. Find the edges of the correctable area to determine its size

4. Determine whether the area is roughly circular

In phase 1, a two-dimensional array is constructed, as shown in FIG. 14, each cell containing either a 1 or 0 to indicate the correctability of the corresponding pixel. The reference pixel 8 is at the centre of the array (column 13, row 13 in FIG. 14). As mentioned above, the array must be large enough that the whole extent of the pupil can be contained within it, and this can be guaranteed by reference to the size of the feature detected in the first place.

In phase 2, a second array is generated, the same size as the first, containing a score for each pixel in the correctable pixels array. As shown in FIG. 15, the score of a pixel 50, 51 is the number of correctable pixels in the 3×3 square centred on the one being scored. In FIG. 15a, the central pixel 50 has a score of 3. In FIG. 15b, the central pixel 51 has a score of 6. Scoring is helpful because it allows small gaps and holes in the correctable area to be bridged, and thus prevent edges from being falsely detected.

The result of calculating pixel scores for the array is shown in FIG. 16. Note that the pixels along the edge of the array are all assigned scores of 9, regardless of what the calculated score would be. The effect of this is to assume that everything beyond the extent of the array is correctable. Therefore if any part of the correctable area surrounding the highlight extends to the edge of the array, it will not be classified as an isolated, closed shape.

Phase 3 uses the pixel scores to find the boundary of the correctable area. The described example only attempts to find the leftmost and rightmost columns, and topmost and bottom-most rows of the area, but there is no reason why a more accurate tracing of the area's boundary could not be attempted.

It is necessary to define a threshold that separates pixels considered to be correctable from those that are not. In this example, any pixel with a score of ≧4 is counted as correctable. This has been found to give the best balance between traversing small gaps whilst still recognising isolated areas.

The algorithm for phase 3 has three steps, as shown in FIG. 17:

1. Start at the centre of the array and work outwards 61 to find the edge of the area.

2. Simultaneously follow the left and right edges 62 of the upper section until they meet.

3. Do the same as step 2 for the lower section 63.

The first step of the process is shown in more detail in FIG. 18. The start point is the central pixel 8 in the array with co-ordinates (13, 13), and the objective is to move from the centre to the edge of the area 64, 65. To take account of the fact that the pixels at the centre of the area may not be classified as correctable (as is the case here), the algorithm does not attempt to look for an edge until it has encountered at least one correctable pixel. The process for moving from the centre 8 to the left edge 64 can be expressed is as follows:

```
current_pixel = centre_pixel
left edge = -undefined
if current_pixel's score < threshold then
        move current_pixel left until current_pixel's score ≧ threshold
end if
move current_pixel left until:
        current_pixel's score < threshold, or
        the beginning of the row is passed
if the beginning of the row was not passed then
        left_edge = pixel to the right of current_pixel
end if
Similarly, the method for locating the right edge 65 can be expressed as:
current_pixel = centre_pixel
right_edge = undefined
if current_pixel's score < threshold then
        move current_pixel right until current_pixel's score ≧
        threshold
end if
move current_pixel right until:
        current_pixel's score < threshold, or
        the end of the row is passed
if the end of the row was not passed then
        right_edge = pixel to the left of current_pixel
end if
```

At this point, the left 64 and right 65 extremities of the area on the centre line are known, and the pixels being pointed to have co-ordinates (5, 13) and (21, 13).

The next step is to follow the outer edges of the area above this row until they meet or until the edge of the array is reached. If the edge of the array is reached, we know that the area is not isolated, and the feature will therefore not be classified as a potential red-eye feature.

As shown in FIG. 19, the starting point for following the edge of the area is the pixel 64 on the previous row where the transition was found, so the first step is to move to the pixel 66 immediately above it (or below it, depending on the direction). The next action is then to move towards the centre of the area 67 if the pixel's value 66 is below the threshold, as shown in FIG. 19a, or towards the outside of the area 68 if the pixel 66 is above the threshold, as shown in FIG. 19b, until the threshold is crossed. The pixel reached is then the starting point for the next move.

The process of moving to the next row, followed by one or more moves inwards or outwards continues until there are no more rows to examine (in which case the area is not isolated), or until the search for the left-hand edge crosses the point where the search for the right-hand edge would start, as shown in FIG. 20.

The entire process is shown in FIG. 21, which also shows the left 64, right 65, top 69 and bottom 70 extremities of the area, as they would be identified by the algorithm. The top edge 69 and bottom edge 70 are closed because in each case the left edge has passed the right edge. The leftmost column 71 of correctable pixels is that with y-coordinate=6 and is one column to the right of the leftmost extremity 64. The rightmost column 72 of correctable pixels is that with y-coordinate=20 and is one column to the right of the rightmost extremity 65. The topmost row 73 of correctable pixels is that with x-coordinate=6 and is one row down from the point 69 at which the left edge passes the right edge. The bottom-most row 74 of correctable pixels is that with x-coordinate=22 and is one row up from the point 70 at which the left edge passes the right edge.

Having successfully discovered the extremities of the area in phase 3, phase 4 now checks that the area is essentially circular. This is done by using a circle 75 whose diameter is the greater of the two distances between the leftmost 71 and rightmost 72 columns, and topmost 73 and bottom-most 74 rows to determine which pixels in the correctable pixels array to examine, as shown in FIG. 22. The circle 75 is placed so that its centre 76 is midway between the leftmost 71 and rightmost 72 columns and the topmost 73 and bottom-most 74 rows. At least 50% of the pixels within the circular area 75 must be classified as correctable (i.e. have a value of 1 as shown in FIG. 14) for the area to be classified as circular 75.

It will be noted that, in this case, the centre 76 of the circle is not in the same position as the reference pixel 8 from which the area detection began.

If it is found that a closed, isolated circular area of correctable pixels is associated with a feature, it is added to a list of such areas.

As an alternative or additional final check, each isolated area may be subjected to a simple test based on the ratio of the height of the area to its width. If it passes, it is added to the list ready for stage (3).

Stage 3—Area Analysis

Some of the areas found in Stage (2) will be caused by red-eyes, but not all. Those that are not are hereafter called ‘false detections’. The algorithm attempts to remove these before applying correction to the list of areas.

Numerous measurements are made on each of the areas, and various statistics are calculated that can be used later (in stage (4)) to assess whether an area is or is not caused by red-eye. The measurements taken include the mean and standard deviation of the Hue, Lightness and Saturation values within each isolated area, and counts of small and large changes between horizontally adjacent pixels in each of the three channels (H, L and S).

The algorithm also records the proportions of pixels in an annulus surrounding the area satisfying several different criteria for H, L and S. It also measures and records more complex statistics, including the mean and standard deviation of H×L in the area (i.e. H×L is calculated for each pixel in the area and the mean and standard deviation of the resulting distribution is calculated). This is done for H×S and L×S as well.

Also recorded are two different measures of the changes in H, L and S across the area: the sum of the squares of differences between adjacent pixels for each of these channels, and the sum of absolute differences between adjacent pixels for each of these channels. Further, two histograms are recorded, one for correctable and one for non-correctable pixels in the area. Both histograms record the counts of adjacent correctable pixels.

The algorithm also calculates a number that is a measure of the probability of the area being a red-eye. This is calculated by evaluating the arithmetic mean, over all pixels in the area, of the product of a measure of the probabilities of that pixel's H, S and L values occurring in a red-eye. (These probability measures were calculated after extensive sampling of red-eyes and consequent construction of the distributions of H, S and L values that occur within them.) A similar number is calculated as a measure of the probability of the area being a false detection. Statistics are recorded for each of the areas in the list.

The area analysis is conducted in a number of phases. The first analysis phase calculates a measure of the probability (referred to in the previous paragraph) that the area is a red-eye, and also a measure of the probability that the area is a false detection. These two measures are mutually independent (although the actual probabilities are clearly complementary).

The algorithm is shown below. The value huePDFp is the probability, for a given hue, of a randomly selected pixel from a randomly selected red-eye of any type having that hue. Similar definitions correspond for satPDFp with respect to saturation value, and for lightPDFp with respect to lightness value. The values huePDFq, satPDFq and lightPDFq are the equivalent probabilities for a pixel taken from a false detection which would be present at this point in the algorithm, i.e. a false detection that one of the detectors would find and which will pass area detection successfully.

```
loop through each pixel in the red eye area
        increment PixelCount
        look up huePDFp
        look up satPDFp
        look up lightPDFp
        calculate huePDFp × satPDFp × lightPDFp
        add the above product to sumOfps (for this area)
        look up huePDFq
        look up satPDFq
        look up lightPDFq
        calculate huePDFq × satPDFq × lightPDFq
        add the above product to sumOfqs (for this area)
end loop
record (sumOfps / PixelCount) for this area
record (sumOfqs / PixelCount) for this area
```

The two recorded values “sumOfps/PixelCount” and “sumofqs/PixelCount” are used later, in the validation of the area, as measures of the probability of the area being a red-eye or a false detection, respectively.

The next phase uses the correctability criterion used above in area detection, whereby each pixel is classified as correctable or not correctable on the basis of its H, L and S values. (The specific correctability criteria used for analysing each area are the same criteria that were used to find that area, i.e. HLS, HaLS or Sat128). The algorithm iterates through all of the pixels in the area, keeping two totals of the number of pixels with each possible count of correctable nearest neighbours (from 0 to 8, including those diagonally touching)—one for those pixels which are not correctable, and one for those pixels which are.

The information that is recorded is:

For all correctable pixels, how many have [x] nearest neighbours that are also correctable where 0≦x≦8

For all non-correctable pixels, how many have [y] nearest neighbours which are correctable, where 0≦y≦8.

These two groups of data are logically two histograms of correctable-nearest-neighbour count, one for correctable, and the other for non-correctable, pixels.

The next phase involves the analysis of an annulus 77 of pixels around the red-eye area 75, as shown in FIG. 23. The area enclosed by the outer edge 78 of the annulus should approximately cover the white of the eye, possibly with some facial skin included. The annulus 77 is bounded externally by a circle 78 of radius three times that of the red-eye area, and internally by a circle of the same radius as the red-eye area 75. The annulus is centred on the same pixel as the red-eye area itself.

The algorithm iterates through all of the pixels in the annulus, classifying each into one or more categories on the basis of its H, L and S values.

| Category | Hue | Saturation | Lightness |
|---|---|---|---|
| LightSatOK | — | S < 100 | L < 200 |
| LightSatOK | — | 100 ≦ S < 200 | 150 < L |
| HueLightOK | 220 ≦ H | — | 15 ≦ L ≦ 200 |
| HueLightOK | H ≦ 30 | — | 15 ≦ L ≦ 230 |
| HueSatOK | H ≦ 30 | 15 ≦ S ≦ 200 | — |
| HueSatOK | 140 ≦ H ≦ 230 | S ≦ 50 | — |
| HueSatOK | 230 ≦ H | S ≦ 100 | — |

There are further supercategories which the pixel is classified as being in, or not, on the basis of which of the above categories it is in. These seven supercategories are ‘All’, ‘LightSatHueSat’, ‘HueLightHueSat’, ‘HueSat’ and so on.

For HueSatOK pixels -

| | HueLightOK | !HueLightOK |
|---|---|---|
| LightSatOK | All | LightSatHueSat |
| !LightSatOK | HueLightHueSat | HueSat |

For !HueSatOK pixels -

| | HueLightOK | !HueLightOK |
|---|---|---|
| LightSatOK | LightSatHueLight | LightSat |
| !LightSatOK | HueLight | — |

(!HueSatOK means that HueSatOK is not true, and so on, the prefix ‘!’ indicating that a condition is false). As an example, a pixel that satisfies HueSatOK (see the first table above) and HueLightOK but not LightSatOK is thus in the supercategory ‘HueLightHueSat’. The algorithm keeps a count of the number of pixels in each of these seven supercategories as it iterates through all of the pixels in the annulus. The proportion of pixels within the annulus falling into each of these categories is stored together with the other information about each red eye, and will be used in stage (4), when the area is validated.

In addition to the classification described above, a further classification is applied to each pixel on this single pass through the annulus.

| Category | Hue | Saturation | Lightness |
|---|---|---|---|
| Hue 1 | 240 ≦ H | — | — |
| Hue 2 | H ≦ 20 | — | — |
| Sat 1 | — | S ≦ 35 | — |
| Sat 2 | — | S ≦ 50 | — |
| Light 1 | — | — | L ≦ 100 |
| Light 2 | — | — | L ≦ 150 |
| Light 3 | — | — | L ≦ 200 |
| Light 4 | — | — | 200 < L |

Again, as above, the pixel is then classified into supercategories according to which of these categories it falls into.

| Criteria | Supercategory |
|---|---|
| Hue1 AND Sat1 AND Light3 | WhiteA |
| Hue1 AND Sat2 AND Light3 | WhiteB |
| Hue1 AND Sat1 AND Light2 | WhiteC |
| Hue1 AND Sat2 AND Light3 | WhiteD |
| Hue2 AND (Sat1 OR Sat2) AND Light2 | WhiteE |
| Hue2 AND (Sat1 OR Sat2) AND Light3 | WhiteF |
| Hue1 AND Sat1 AND Light4 | WhiteI |
| Hue1 AND Sat2 AND Light4 | WhiteJ |
| Hue1 AND Sat1 AND Light1 | WhiteK |
| Hue1 AND Sat2 AND Light1 | WhiteL |
| (Sat1 OR Sat2) AND Light2 | WhiteX |
| (Sat1 OR Sat2) AND Light3 | WhiteY |

Unlike their base categories, these supercategories are mutually exclusive, excepting WhiteX and WhiteY, which are supersets of other supercategories. The algorithm keeps a count of the number of pixels in each of these twelve supercategories as it iterates through all of the pixels in the annulus. These counts are stored together with the other information about each red eye, and will be used in stage 4, when the area is validated. This completes the analysis of the annulus.

Also analysed is the red-eye area itself. This is performed in three passes, each one iterating through each of the pixels in the area. The first pass iterates through the rows, and within a row, from left to right through each pixel in that row. It records various pieces of information for the red-eye area, as follows.

```
for each row in the red-eye area
        increment RowCount
        loop through each pixel in the row doing
                increment PixelCount
                add this pixel's lightness to Lsum
                add this pixel's saturation to Ssum
                if this pixel is not the first on the row
                        calculate the lightness change from the previous pixel to this
                        calculate the saturation change from the previous pixel to this
                end if
                if lightness change is above the Lmedium threshold
                increment Lmed
                if lightness change is above the Llarge threshold
                        increment Lbig
                end if
        end if
        if saturation change is above the Smedium threshold
                increment Smed
                if saturation change is above the Slarge threshold
                        increment Sbig
                end if
        end if
        add the square of the lightness change to the rolling sum Lsqu
        add the absolute value of the lightness change to the rolling sum Labs
        add the square of the saturation change to the rolling sum Ssqu
        add the absolute value of the saturation change to the rolling sum Sabs
end loop
next row
record RowCount, PixelCount, Lsqu, Labs, Lmed, Lbig, Lsum, Ssqu, Sabs,
        Smed, Sbig and Ssum with the other data for this red-eye area
```

Lmedium, Llarge, Smedium and Slarge are thresholds specifying the size a change must be in order to be categorised as medium sized (or bigger) and big, respectively.

The second pass through the red-eye area iterates through the pixels in the area summing the hue, saturation and lightness values over the area, and also summing the value of (hue×lightness), (hue×saturation) and (saturation×lightness). The hue used here is the actual hue rotated by 128 (i.e. 180 degrees on the hue circle). This rotation moves the value of reds from around zero to around 128. The mean of each of these six distributions is then calculated by dividing these totals by the number of pixels summed over.

The third pass iterates through the pixels and calculates the variance and population standard deviation for each of the six distributions (H, L, S, H×L, H×S, S×L). The mean and standard deviation of each of the six distributions is then recorded with the other data for this red-eye area.

This completes the area analysis. At the end of this stage, each area in the list will have associated with it a significant amount of information which is then used to determine whether or not the area should stay in the list.

Stage 4—Area Validation

The algorithm now uses the data gathered in stage (3) to reject some or all of the areas in the list. For each of the statistics recorded, there is some range of values that occur in red eyes, and for some of the statistics, there are ranges of values that occur only in false detections. This also applies to ratios and products of two or three of these statistics.

The algorithm uses tests that compare a single statistic, or a value calculated from some combination of two or more of them, to the values that are expected in red eyes. Some tests are required to be passed, and the area will be rejected (as a false detection) if it fails those tests. Other tests are used in combination, so that an area must pass a certain number of them—say, four out of six—to avoid being rejected.

As noted above, there are five different feature types that may give rise in stage (2) to an area, and three different sets of criteria for H, L and S that may be used to find an area given a feature, although not all of the sets of criteria are applicable to all of the feature types. The areas can be grouped into 10 categories according to these two properties. Eyes that are detected have some properties that vary according to the category of area they are detected with, so the tests that are performed for a given area depend on which of these 10 categories the area falls into. For this purpose, the tests are grouped into validators, of which there are many, and the validator used by the algorithm for a given area depends on which category it falls into. This, in turn, determines which tests are applied.

Further to this level of specificity in the validators, the amount of detail within, and the characteristics of, a red-eye area are slightly different for larger red-eyes (that is, ones which cover more pixels in the image.) There are therefore additional validators specifically for eyes that are large, which perform tests that large false detections may fail but large eyes will not (although smaller eyes may fail them).

An area may be passed through more than one validator—for instance, it may have one validator for its category of area, and a further validator because it is large. In this case, it must pass all the relevant validators to be retained. A validator is simply a collection of tests tailored for some specific subset of all areas.

One group of tests uses the seven supercategories first described in Stage 3—Area Analysis (not the ‘White’ supercategories). For each of these categories, the proportion of pixels within the area that are in that supercategory must be within a specified range. There is thus one such test for each category, and a given validator will require a certain number of these seven tests to be passed in order to retain the area. If more tests are failed, the area will be rejected.

Examples of other tests include

if Lsum < (someThreshold × PixelCount) reject area
if (someThreshold × Lmed × RowCount) < Lsum reject area
if (Labs / Lsum) > someThreshold reject area
if mean Lightness > someThreshold reject area
if standard deviation of (S × L) < someThreshold reject area
if Ssqu > (standard deviation of S × someThreshold) reject area

The skilled person will readily appreciate the nature and variety of tests possible. The preferred implementation will use all possible non-redundant such tests which can discriminate between true red-eye areas and the areas of false detections.

Stage 5—Area Removal by Interaction

In this stage, some of the areas still in the list are now removed because of interactions between the areas. For each area, a circle is constructed which just circumscribes that area—this circle has the same centre as the area, and is just large enough to contain it. If the circles for two or more areas intersect, they are considered for removal.

The area detected associated with a genuine red-eye (true detection) in an image will be the pupil, and may spill over into the iris or white of the eye. Pupils cannot overlap, and nor can irises (or indeed entire eyes). Genuine red-eyes will therefore not cause intersecting areas, and in such cases both areas should be deleted from the list.

However, special consideration must be given because there may be more than one area in the list associated with the same red-eye—i.e. the same red-eye may have been detected more than once. It may have been identified by more than one of the five different feature detection algorithms, and/or have had more than one area associated with it during area detection due to the fact that there are three different sets of correctability criteria that may be used to find an area.

If this is the case, in theory there may be up to ten overlapping areas that are associated with a single red-eye in the image, although in practice (because of the different detection requirements for different features), it is unusual to find more than five. It is not desirable to apply correction to any red-eye more than once, so only one of these areas should be used for correction, but one of them must be retained or else the red-eye will not be corrected.

It is desirable to retain the area which will give the most natural looking result after correction. Rules have been determined for all combinations of area categories which specify which area is the best one to retain. This depends on the degree of overlap of the areas, their absolute and relative sizes and the categories they belong to. Therefore, for areas that overlap (intersect) or are very close to each other, the algorithm applies several rules to determine which of them to keep. They may all be rejected. At the end of this stage there remains a list of areas, each of which, so far as the algorithm may assess, is associated with a red-eye in the image.

The algorithm performs this task in four phases, the first three of which remove circles according to their interactions with other circles, and the last of which removes all but one of any sets of duplicate (identical) circles.

These four phases are best understood by considering the algorithm used by each one, represented below in pseudo-code. An entry such as “‘this’ is type 4 HLS” refers to the feature type and area detection category respectively. In this example it means that the entry in the possible red-eye list was detected as a feature by the type 4 detector and the associated area was found using the correctability criteria HLS described in stage (2). A suitable value for OffsetThreshold might be 3, and RatioThreshold might be ⅓.

Phase 1

```
for each circle in the list of possible red-eyes (‘this’)
        for each other circle after ‘this’ in the list of possible red-eyes (‘that’)
                if ‘this’ and ‘that’ have both been marked for deletion in phase one
                        advance to the next ‘that’ in the inner for loop
                end if
                if ‘this’ circle and ‘that’ circle do not intersect at all
                        advance to the next ‘that’ in the inner “for” loop
                end if
                if ‘this’ is type 4 HLS and ‘that’ is not
                        mark ‘this’ for deletion
                        advance to the next ‘that’ in the inner “for” loop
                end if
                if ‘that’ is type 4 HLS and ‘this’ is not
                        mark ‘that’ for deletion
                        advance to the next ‘that’ in the inner “for” loop
                end if
                if ‘this’ and ‘that’ overlap by more than OverlapThreshold
                        advance to the next ‘that’ in the inner “for” loop
                end if
                if ‘this’ circle has same radius as ‘that’ circle
                        if horizontal distance between ‘this’ centre and ‘that’ centre
                        . . . is less than OffsetThreshold AND vertical distance between
                        . . . ‘this’ centre and ‘that’ centre is less than OffsetThreshold
                                advance to the next ‘that’ in the inner “for” loop
                        end if
                else
                        if the smaller of ‘this’ and ‘that’ circle is HaLS AND the
                        . . . smaller circle's radius is less than RatioThreshold times
                        . . . the larger circle's radius
                                advance to the next ‘that’ in the inner “for” loop
                        end if
                end if
                RemoveLeastPromisingCircle(‘this, ‘that’)
        next ‘that’
next ‘this’
```

“RemoveLeastPromisingCircle” is a function implementing an algorithm that selects from a pair of circles which of them should be marked for deletion, and proceeds as follows:

```
if ‘this’ is Sat128 and ‘that’ is NOT Sat128
        mark ‘that’ for deletion
        end
end if
if ‘that’ is Sat128 and ‘this’ is NOT Sat128
        mark ‘this’ for deletion
        end
end if
if ‘this’ is type 4 and ‘that’ is NOT type 4
        mark ‘that’ for deletion
        end
end if
if ‘that’ is type 4 and ‘this’ is NOT type 4
        mark ‘this’ for deletion
        end
end if
if ‘this’ probability of red-eye is less than ‘that’ probability of red-eye
        mark ‘this’ for deletion
        end
end if
if ‘that’ probability of red-eye is less than ‘this’ probability of red-eye
        mark ‘that’ for deletion
        end
end if
if ‘this’ and ‘that’ have different centres or different radii
        mark for deletion whichever of ‘this’ and ‘that’ is first in the list
        end
end if
```

The references to ‘probability of red-eye’ use the measure of the probability of a feature being a red-eye that was calculated and recorded in the area analysis stage (3) described above.

Phase 2

```
for each circle in the list of possible red-eyes (‘this’)
        if this circle was marked for deletion in phase one
                advance to the next ‘this’
        end if
        for each other circle after ‘this’ in the list of possible red-eyes (‘that’)
                if ‘this’ was marked for deletion in phase one
                        advance to the next ‘that’ in the inner for loop
                end if
                if ‘this’ and ‘that’ have both been marked for deletion in phase two
                        advance to the next ‘that’ in the inner for loop
                end if
                if ‘this’ circle's radius equals ‘that’ circles radius
                        if horizontal distance between ‘this’ centre and ‘that’ centre
                        . . . is less than OffsetThreshold AND vertical distance between
                        . . . ‘this’ centre and ‘that’ centre is less than OffsetThreshold
                        . . . AND ‘this’ circle intersects with ‘that’ circle
                                advance to the next ‘that’ in the inner for loop
                        end if
                else
                        if the smaller of ‘this’ and ‘that’ circle is HaLS AND the
                        . . . distance between their centres is less than
                        . . . 1.1 × (1 + the sum of their radii) AND the ratio of
                        . . . the smaller to the larger radius is less than 1/3
                                mark the smaller of ‘this’ and ‘that’ for deletion
                        end if
                        if ‘this’ circle and ‘that’ circle intersect AND the overlap
                        . . . area as a proportion of the area of the smaller circle
                        . . . is greater than OverlapThreshold
                                if the smaller of the two radii × 1.5 is greater than
                                . . . the larger of the two radii
                                        RemoveLeastPromisingCircle( ‘this’, ‘that’ )
                                else
                                        mark the smaller of ‘this’ and ‘that’ for deletion
                                end if
                        end if
                end if
        next ‘that’
next ‘this’
```

Phase 3

```
for each circle in the list of possible red-eyes (‘this’)
    if this circle was marked for deletion in phase one or phase two
        advance to the next ‘this’
    end if
    for each other circle after ‘this’ in the list of possible red-eyes (‘that’)
        if ‘this’ was marked for deletion in phase one or phase two
            advance to the next ‘that’ in the inner for loop
        end if
        if ‘this’ and ‘that’ have both been marked for deletion in phase
        three
            advance to the next ‘that’ in the inner for loop
        end if
        if neither ‘this’ nor ‘that’ is type 4 HLS AND ‘this’ and ‘that’
        do not
        ... intersect
            if the distance between the circles is less than the smaller of
            ... their radii
                mark ‘this’ and ‘that’ for deletion
            end if
        end if
    next ‘that’
next ‘this’
for each circle in the list of possible red-eyes
    if this circle has been marked for deletion
        remove it from the list
    end if
next circle
```

The above three phases mark circles for deletion, singly or in pairs based upon pairwise interactions between circles, and the third finishes by running through the list of possible red-eyes and removing those that have been thus marked for deletion.

Phase 4
The fourth phase removes all but one of any
sets of duplicate circles that remain in the
list of possible red-eyes.

```
for each circle in the list of possible red-eyes (‘this’)
    for each other circle after ‘this’ in the list of possible red-eyes (‘that’)
        if ‘this’ circle has the same centre, radius, area detection and
        ... correctability criterion as ‘that’ circle
            remove ‘this’ circle from the list of possible red-eyes
        end if
    next ‘that’
next ‘this’
```

At the end of this stage, each area in the list of areas should correspond to a single red-eye, with each red-eye represented by no more than one area. The list is now in a suitable condition for correction to be applied to the areas.

Stage 6—Area Correction

In this stage, correction is applied to each of the areas remaining in the list. The correction is applied as a modification of the H, S and L values for the pixels in the area. The algorithm is complex and consists of several phases, but can be broadly categorised as follows.

A modification to the saturation of each pixel is determined by a calculation based on the original hue, saturation and lightness of that pixel, the hue, saturation and lightness of surrounding pixels and the shape of the area. This is then smoothed and a mimetic radial effect introduced to imitate the circular appearance of the pupil, and its boundary with the iris, in an “ordinary” eye (i.e. one in which red-eye is not present) in an image. The effect of the correction is diffused into the surrounding area to remove visible sharpness and other unnatural contrast that correction might otherwise introduce.

A similar process is then performed for the lightness of each pixel in and around the correctable area, which depends on the saturation correction calculated from the above, and also on the H, S and L values of that pixel and its neighbours. This lightness modification is similarly smoothed, radially modulated (that is, graduated) and blended into the surrounding area.

After these saturation and lightness modifications have been applied to the image, a further modification is applied which reduces the saturation of any pixels that remain essentially red. This correction depends upon R, G, B colour data for each of the pixels, as well as using H, S, L data. Effort is made to ensure that the correction blends smoothly around and across the eye, so that no sharp changes of lightness or saturation are introduced.

Finally all of the corrected eyes are checked to determine whether or not they still appear to be “flares”. Eyes that, after correction, are made up predominantly of light, unsaturated pixels and appear to have no highlight are further modified so that they appear to have a highlight, and so that they appear darker.

The correction process will now be described in more detail.

Saturation Multipliers

A rectangle around the correctable area is constructed, and then enlarged slightly to ensure that it fully encompasses the correctable area and allows some room for smoothing of the correction. Several matrices are constructed, each of which holds one value per pixel within this area.

On a 2D grid of lightness against saturation value, the algorithm calculates the distance of each pixel's lightness (L) and saturation (S) value from the point L=128, S=255. FIG. 24 show how this calculation is made for a single example pixel 80 having (L,S)=(100,110). The distance from (L,S)=(128,255) is the length of the line 81 joining the two points. In this example this distance is √((128-100)²+(255-110)²)=157.5. This gives a rough measure of how visibly coloured the pixel appears to be: the shorter the distance, the more saturated the pixel appears to the eye. The algorithm marks for correction only those pixels with a distance of less than 180 (below the cut-off line 82 in FIG. 24), and whose hue falls within a specific range. The preferred implementation will use a range similar to (Hue≧220 or Hue≦21), which covers the red section of the hue wheel.

For each such pixel, the algorithm calculates a multiplier for its saturation value—some need substantial de-saturation to remove redness, others need little or none. The multiplier determines the extent of correction—a multiplier of 1 means full correction, a multiplier of 0 means no correction. This multiplier depends on the distance calculated earlier. Pixels with L, S values close to 128, 255 are given a large multiplier, (i.e. close to one) while those with L, S values a long way from 128, 255 have a small multiplier, smoothly and continuously graduated to 0 (which means the pixel will be uncorrected). Thereby the correction is initially fairly smooth. If the distance is less than 144, the multiplier is 1. Otherwise, it is 1−((distance−144)/36).

An assessment is now made of whether to proceed further. If there is a large proportion of pixels (>35%) on the boundaries of the rectangle that have a high calculated correction (>0.85), the algorithm does not proceed any further. This is because the rectangle should contain an eye, and only a correctable area of a shape that could not represent an eye would cause a pattern of multipliers with high values near the rectangle's edges.

The algorithm now has a grid of saturation multipliers, one per pixel for the rectangle of correction. To mimic the circularity of the pupil and iris of an eye, and ensure that the correction is graduated radially (to improve smoothness still further) it applies a circular, radial adjustment to each of these multipliers, as shown in FIG. 25. The adjustment is centred at the midpoint of the rectangle 83 bounding the correctable region. This leaves multipliers near the centre of the rectangle unchanged, but graduates the multipliers in an annulus 84 around the centre so that they blend smoothly into 0 (which means no correction) near the edge of the area 83. The graduation is smooth and linear moving radially from the inner edge 85 of the annulus (where the correction is left as it was) to the outer edge (where any correction is reduced to zero effect). The outer edge of the annulus touches the corners of the rectangle 83. The radii of the inner and outer edges of the annulus are both calculated from the size of the (rectangular) correctable area.

The edges of the correction are now softened. (This is quite different from the above smoothing steps.) A new multiplier is calculated for each non-correctable pixel. As shown in FIG. 26, the pixels affected are those with a multiplier value of 0, i.e. non-correctable 86, which are adjacent to correctable pixels 87. The pixels 86 affected are shown in FIG. 26 with horizontal striping. Correctable pixels 87, i.e. those with a saturation multiplier above 0, are shown in FIG. 26 with vertical striping.

The new multiplier for each of these pixels is calculated by taking the mean of the previous multipliers over a 3×3 grid centred on that pixel. (The arithmetic mean is used, i.e. sum all 9 values and then divide by 9). The pixels just outside the boundary of the correctable region thus have the correction of all adjacent pixels blurred into them, and the correction is smeared outside its previous boundary to produce a smooth, blurred edge. This ensures that there are no sharp edges to the correction. Without this step, there may be regions where pixels with a substantial correction are adjacent to pixels with no correction at all, and such edges could be visible. Because this step blurs, it spreads the effect of the correction over a wider area, increasing the extent of the rectangle that contains the correction.

This edge-softening step is then repeated once more, determining new multipliers for the uncorrectable pixels just outside the (now slightly larger) circle of correctable pixels.

Having established a saturation multiplier for each pixel, the correction algorithm now moves on to lightness multipliers.

Lightness Multipliers

The calculation of lightness multipliers involves similar steps to the calculation of saturation multipliers, but the steps are applied in a different order.

Initial lightness multipliers are calculated for each pixel (in the rectangle bounding the correctable area). These are calculated by taking, for each pixel, the mean of the saturation multipliers already determined, over a 7×7 grid centred on that pixel. The arithmetic mean is used, i.e. the algorithm sums all 49 values then divides by 49. The size of this grid could, in principle, be changed to e.g. 5×5. The algorithm then scales each per-pixel lightness multiplier according to the mean size of the saturation multiplier over the entire bounding rectangle (which contains the correctable area). In effect, the size of each lightness adjustment is (linearly) proportional to the total amount of saturation adjustment calculated in the above pass.

An edge softening is then applied to the grid of lightness multipliers. This uses the same method as that used to apply edge softening to the saturation multipliers, described above with reference to FIG. 26.

The whole area of the lightness correction is then smoothed. This is performed in the same way as the edge softening just performed, except that this time the multiplier is re-calculated for every pixel in the rectangle, not just those which were previously non-correctable. Thus, rather than just smoothing the edges, this smoothes the entire area, so that the correction applied to lightness will be smooth all over.

The algorithm then performs a circular blending on the grid of lightness multipliers, using a similar method to that used for radial correction on the saturation multipliers, described with reference to FIG. 25. This time, however, the annulus 88 is substantially different, as shown in FIG. 27. The radii of the inner 89 and outer 90 radii of the annulus 88 across which the lightness multipliers are graduated to 0 are substantially less then the corresponding radii 85, 83 used for radial correction of the saturation multipliers. This means that the rectangle will have regions 91 in the corners thereof where the lightness multipliers are set to 0.

Each pixel in the correctable area rectangle now has a saturation and lightness multiplier associated with it.

Use of Multipliers to Modify Saturation and Lightness

For each pixel in the rectangle, (which has been extended by the softening/blurring as described above) the correction is now applied by modifying its saturation and lightness values. The hue is not modified.

The saturation is corrected first, but only if it is below 200 or the saturation multiplier for that pixel is less than 1 (1 means full correction, 0 means no correction)—if neither of these conditions is satisfied, the saturation is reduced to zero. If it is to be corrected, the new saturation is calculated as

CorrectedSat=(OldSat×(1−SatMultiplier))+(SatMultiplier×64)

Thus, if the multiplier is 1, which means full correction, the saturation will be changed to 64. If the multiplier is 0, which means no correction, the saturation is unchanged. For other values of the multiplier, the saturation will be corrected from its original value towards 64, and how far it will be corrected increases as the multiplier's value increases.

For each pixel in the rectangle further correction is now applied by modifying its lightness, but only if its corrected saturation as just calculated is not zero and its lightness is less than 220. If it does not satisfy both of these conditions, the lightness is not changed. The 220 lightness threshold ensures that pixels in the central “highlight” (if it is present) retain their lightness, so that highlights are not removed by the correction—although they may be desaturated to remove any redness, they will still be very light. If it is to be corrected, the new lightness value is calculated as

CorrectedLight=OldLight×(1−LightMultiplier)

A final correction to saturation is then applied, again on a per-pixel basis but this time using RGB data for the pixel. For each pixel in the rectangle if, after the correction so far has been applied, the R-value is higher than both G and B, an adjustment is calculated:

Adjustment=1−(0.4×SatMultiplier)

where SatMultiplier is the saturation multiplier already used to correct the saturation. These adjustments are stored in another grid of values. The algorithm applies smoothing to the area of this new grid of values, modifying the adjustment value of each pixel to give the mean of the 3×3 grid surrounding that pixel. It then goes through all of the pixels in the rectangle except those at an edge (i.e. those inside but not on the border of the rectangle) and applies the adjustment as follows:

FinalSat=CorrectedSat×Adjustment

CorrectedSat is the saturation following the first round of saturation correction. The effect of this is that saturation is further reduced in pixels that were still essentially red even after the initial saturation and lightness correction.

Flare Correction

Even after the correction described above, some eyes may still appear unnatural to the viewer. Generally, these are eyes which do not have a highlight, and which, following the correction procedure, are predominantly made up of very light, unsaturated pixels. This makes the pupil look unnatural, since it appears light grey instead of black. It is therefore necessary to apply a further correction to these corrected eyes to create a simulated dark pupil and light highlight.

The grey corrected pupil is identified and its shape determined. The pupil is “eroded” to a small, roughly central point. This point becomes a highlight, and all other light grey pixels are darkened, turning them into a natural-looking pupil.

Flare correction proceeds in two stages. In the first stage all corrected eyes are analysed to see whether the further correction is necessary. In the second stage a further correction is made if the relative sizes of the identified pupil and highlight are within a specified range.

The rectangle used for correction in the previous stages is constructed for each corrected red-eye feature. Each pixel within the rectangle is examined, and a record is made of those pixels, which are light, “red”, and unsaturated—i.e. satisfying the criteria:

((0≦Hue≦21) OR (220≦Hue≦255)) AND (Saturation≦50) AND (Lightness≧128)

A 2D grid 301 corresponding to the rectangle is created as shown in FIG. 28, in which pixels 302 satisfying these criteria are marked with a score of one, and all other pixels 303 are marked with a score of zero. This provides a grid 301 (designated as grid A) of pixels 302 which will appear as a light, unsaturated region within the red-eye given the correction so far. This roughly indicates the region that will become the darkened pupil.

Grid A 301 is copied into a second grid 311 (grid B) as shown in FIG. 29, and the pupil region is “eroded” down to a small number of pixels 312. The erosion is performed in multiple passes. Each pass sets to zero all remaining pixels 305 having a score of one which have fewer than five non-zero nearest neighbours (or six, including themselves—i.e. a pixel is set to zero if the 3×3 block on which it is centred contains fewer than six non-zero pixels). This erosion is repeated until no pixels remain, or the erosion has been performed 20 times. The version 311 of grid B immediately prior to the last erosion operation is recorded. This will contain one or more—but not a large number of—pixels 312 with scores of one. These pixels 312 will become the highlight.

The pixels in grid A 301 are again re-analysed and all those pixels 304 having saturation greater than 2 are marked as zero. This eliminates all pixels except those which have almost no visible colouration, so those that remain will be those that appear white or very light grey. The results are saved in a new grid 321 (grid C), as shown in FIG. 30. It will be noted that this has removed most of the pixels around the edge of the area, leaving only most of the pupil pixels 322 in place.

Every pixel in grid C 321 is now examined again, and marked as zero if it has fewer than three non-zero nearest neighbours (or four, including itself). This removes isolated pixels and very small isolated islands of pixels. The results are saved in a further grid 331 (grid D), as shown in FIG. 31. In the example shown in the figures, there were no isolated pixels in grid C 321 to be removed, so grid D 331 is identical to grid C 321. It will be appreciated that this will not always be the case.

Every pixel in grid B 311 is now examined again, and those pixels that are zero in grid D 331 are marked as zero in grid B 311 to yield a further grid 341 (grid E), as shown in FIG. 32. In the example shown, grid E and grid B are identical, but it will be appreciated that this will not always be the case. For example, if the corrected eye does have a saturated highlight, the central pixels in grids C and D 321, 331 will have a saturation greater then 2 and will thus have been marked as zero. These would then overlap with the central pixels 312 in grid B, in which case all of the pixels in grid E 341 would be set to zero.

As the above iteration is performed, the number of non-zero pixels 332 in grid D 331 is recorded, together with the number of non-zero pixels 342 remaining in grid E 341. If the count of non-zero pixels 342 in grid E 341 is zero or the count of non-zero pixels 332 in grid D 331 is less than 8, no flare correction is applied to this area and the algorithm stops.

In addition, no further correction is performed if the ratio of the count of non-zero pixels 342 in grid E 341 to the count of non-zero pixels 332 in grid D 341 is less than some threshold—for example 0.19. This means that the eye is likely to have contained a correctly-sized highlight, and that the pupil is dark enough.

The analysis stages are now complete. Grid D 331 contains the pupil region 332, and grid E 341 contains the highlight region 342.

If further correction is to be applied, the next step is application of an appropriate correction using the information gathered in the above steps. Edge softening is first applied to grid D 331 and grid E 341. This takes the form of iterating through each pixel in the grid and, for those that have a value of zero, setting their value to one ninth of the sum of the values of their eight nearest neighbours (before this softening). The results for grid D 351 and grid E 361 are shown in FIGS. 33 and 34 respectively. Because this increases the size of the area, the grids 351, 361 are both extended by one row (or column) in each direction to ensure that they still accommodate the whole set of non-zero values. While previous steps have placed only values of one or zero into the grids, this step introduces values that are multiples of one-ninth.

After this edge softening has been performed, correction proper can begin, modifying the saturation and/or lightness of the pixels within the red-eye area. An iteration is performed through each of the pixels in the (now enlarged) rectangle associated with the area. For each of these pixels, two phases of correction are applied. In the first, if a pixel 356 has a value greater than zero in grid D 351 and less than one in grid E 361, the following correction is applied:

NewSaturation=0.1*OldLightness+16

NewLighntess=0.3*OldLightness

Then, if the value of the pixel 356 in grid D is less than 1 (but still>0 in grid D and <1 in grid E),

NewLightness=NewLightness*grid D value

Otherwise, if the grid D value of the pixel 357 is 1 (and still <1 in grid E),

NewSaturation=NewSaturation+16

These lightness and saturation values are clipped at 255; any value greater than 255 will be set to 255.

A further correction is then applied for those pixels 362, 363 that have a non-zero value in grid E 361. If the grid E value of the pixel 362 is one, then the following correction is applied:

NewSaturation=128

NewLightness=255

If the grid E value of the pixel 363 is non-zero but less than one,

NewSaturation=OldSaturation×grid E value

NewLightness=1020×grid E value

As before, these values are clipped at 255.

This completes the correction.

The method according to the invention provides a number of advantages. It works on a whole image, although it will be appreciated that a user could select part of an image to which red-eye reduction is to be applied, for example just a region containing faces. This would cut down on the processing required. If a whole image is processed, no user input is required. Furthermore, the method does not need to be perfectly accurate. If red-eye reduction is performed on a feature not caused by red-eye, it is unlikely that a user would notice the difference.

Since the red-eye detection algorithm searches for light, highly saturated points before searching for areas of red, the method works particularly well with JPEG-compressed images and other formats where colour is encoded at a low resolution.

The detection of different types of highlight improves the chances of all red-eye features being detected. Furthermore, the analysis and validation of areas reduces the chances of a false detection being erroneously corrected.

It will be appreciated that variations from the above described embodiments may still fall within the scope of the invention. For example, the method has been described with reference to people's eyes, for which the reflection from the retina leads to a red region. For some animals, “red-eye” can lead to green or yellow reflections. The method according to the invention may be used to correct for this effect. Indeed, the initial search for highlights rather than a region of a particular hue makes the method of the invention particularly suitable for detecting non-red animal “red-eye”.

Furthermore, the method has generally been described for red-eye features in which the highlight region is located in the centre of the red pupil region. However the method will still work for red-eye features whose highlight region is off-centre, or even at the edge of the red region.

1. A method of detecting red-eye features in a digital image, comprising:
identifying pupil regions in the image by searching for a row of pixels having a predetermined saturation and/or lightness profile;
identifying further pupil regions in the image by searching for a row of pixels having a different predetermined saturation and/or lightness profile; and
determining whether each pupil region corresponds to part of a red-eye feature on the basis of further selection criteria.

2. A method as claimed in claim 1, comprising identifying two or more types of pupil regions, a pupil region in each type being identified by a row of pixels having a saturation and/or lightness profile characteristic of that type.

3. A method as claimed in claim 2, wherein a first type of pupil region has a saturation profile including a region of pixels having higher saturation than the pixels therearound.

4. A method as claimed in claim 2 or 3, wherein a second type of pupil region has a saturation profile including a saturation trough bounded by two saturation peaks, the pixels in the saturation peaks having higher saturation than the pixels in the area outside the saturation peaks.

5. A method as claimed in claim 2, 3 or 4, wherein a third type of pupil region has a lightness profile including a region of pixels whose lightness values form a “W” shape.

6. A method as claimed in any of claims 2 to 5, wherein a fourth type of pupil region has a saturation and lightness profile including a region of pixels bounded by two local saturation minima, wherein:
at least one pixel in the pupil region has a saturation higher than a predetermined saturation threshold;
the saturation and lightness curves of pixels in the pupil region cross twice; and
two local lightness minima are located in the pupil region.

7. A method as claimed in claim 6, wherein the predetermined saturation threshold is about 100.

8. A method as claimed in claim 7, wherein:
the saturation of at least one pixel in the pupil region is at least 50 greater than the lightness of that pixel;
the saturation of the pixel at each local lightness minimum is greater than the lightness of that pixel;
one of the local lightness minima includes the pixel having the lowest lightness in the region between the two lightness minima; and
the lightness of at least one pixel in the pupil region is greater than a predetermined lightness threshold.

9. A method as claimed in claim 6, 7 or 8, wherein the hue of the at least one pixel having a saturation higher than a predetermined threshold is greater than about 210 or less than about 20.

10. A method as claimed in any preceding claim, wherein a fifth type of pupil region has a saturation and lightness profile including a high saturation region of pixels having a saturation above a predetermined threshold and bounded by two local saturation minima, wherein:
the saturation and lightness curves of pixels in the pupil region cross twice at crossing pixels;
the saturation is greater than the lightness for all pixels between the crossing pixels; and
two local lightness minima are located in the pupil region.

11. A method as claimed in claim 10, wherein:
the saturation of pixels in the high saturation region is above about 100;
the hue of pixels at the edge of the high saturation region is greater than about 210 or less than about 20; and
no pixel up to four outside each local lightness minimum has a lightness lower than the pixel at the corresponding local lightness minimum.

12. A method of correcting red-eye features in a digital image, comprising:
generating a list of possible features by scanning through each pixel in the image searching for saturation and/or lightness profiles characteristic of red-eye features;
for each feature in the list of possible features, attempting to find an isolated area of correctable pixels which could correspond to a red-eye feature;
recording each successful attempt to find an isolated area in a list of areas;
analysing each area in the list of areas to calculate statistics and record properties of that area;
validating each area using the calculated statistics and properties to determine whether or not that area is caused by red-eye;
removing from the list of areas those which are not caused by red-eye;
removing some or all overlapping areas from the list of areas; and
correcting some or all pixels in each area remaining in the list of areas to reduce the effect of red-eye.

13. A method as claimed in claim 12, wherein the step of generating a list of possible features is performed using a method as claimed in any of claims 1 to 11.

14. A method of correcting an area of correctable pixels corresponding to a red-eye feature in a digital image, comprising:
constructing a rectangle enclosing the area of correctable pixels;
determining a saturation multiplier for each pixel in the rectangle, the saturation multiplier calculated on the basis of the hue, lightness and saturation of that pixel;
determining a lightness multiplier for each pixel in the rectangle by averaging the saturation multipliers in a grid of pixels surrounding that pixel;
modifying the saturation of each pixel in the rectangle by an amount determined by the saturation multiplier of that pixel; and
modifying the lightness of each pixel in the rectangle by an amount determined by the lightness multiplier of that pixel.

15. A method as claimed in claim 14, wherein the step of determining the saturation multiplier for each pixel includes:
on a 2D grid of saturation against lightness, calculating the distance of the pixel from a calibration point having predetermined lightness and saturation values;
if the distance is greater than a predetermined threshold, setting the saturation multiplier to be 0 so that the saturation of that pixel will not be modified; and
if the distance is less than or equal to the predetermined threshold, calculating the saturation multiplier based on the distance from the calibration point so that it approaches 1 when the distance is small, and 0 when the distance approaches the threshold, so that the multiplier is 0 at the threshold and 1 at the calibration point.

16. A method as claimed in claim 15, wherein the calibration point has lightness 128 and saturation 255.

17. A method as claimed in claim 15 or 16, wherein the predetermined threshold is about 180.

18. A method as claimed in claim 15, 16 or 17, wherein the saturation multiplier for a pixel is set to 0 if the hue of that pixel is between about 20 and about 220.

19. A method as claimed in any of claims 14 to 18, further comprising applying a radial adjustment to the saturation multipliers of pixels in the rectangle, the radial adjustment comprising:
leaving the saturation multipliers of pixels inside a predetermined circle within the rectangle unchanged; and
smoothly graduating the saturation multipliers of pixels outside the predetermined circle from their previous values, for pixels at the predetermined circle, to 0 for pixels at the corners of the rectangle.

20. A method as claimed in any of claims 14 to 19, further comprising:
for each pixel immediately outside the area of correctable pixels, calculating a new saturation multiplier by averaging the value of the saturation multipliers of pixels in a 3×3 grid around that pixel.

21. A method as claimed in any of claims 14 to 20, further comprising:
scaling the lightness multiplier of each pixel according to the mean of the saturation multipliers for all of the pixels in the rectangle.

22. A method as claimed in any of claims 14 to 21, further comprising:
for each pixel immediately outside the area of correctable pixels, calculating a new lightness multiplier by averaging the value of the lightness multipliers of pixels in a 3×3 grid around that pixel.

23. A method as claimed in any of claims 14 to 22, further comprising:
for each pixel in the rectangle, calculating a new lightness multiplier by averaging the value of the lightness multipliers of pixels in a 3×3 grid around that pixel.

24. A method as claimed in any of claims 14 to 23, further comprising applying a radial adjustment to the lightness multipliers of pixels in the rectangle, the radial adjustment comprising:
leaving the lightness multipliers of pixels inside an inner predetermined circle within the rectangle unchanged; and
smoothly graduating the lightness multipliers of pixels outside the inner predetermined circle from their previous values, for pixels at the inner predetermined circle, to 0 for pixels at or outside an outer predetermined circle having a diameter greater than the dimensions of the rectangle.

25. A method as claimed in any of claims 14 to 24, wherein the step of modifying the saturation of each pixel includes:
if the saturation of the pixel is greater than or equal to 200, setting the saturation of the pixel to 0; and
if the saturation of the pixel is less than 200, modifying the saturation of the pixel such that the modified saturation=(saturation×(1−saturation multiplier))+(saturation multiplier×64).

26. A method as claimed in any of claims 14 to 25, wherein the step of modifying the lightness of each pixel includes:
if the saturation of the pixel is not zero and the lightness of the pixel is less than 220, modifying the lightness such that the modified lightness=lightness×(1−lightness multiplier).

27. A method as claimed in any of claims 14 to 26, comprising applying a further reduction to the saturation of each pixel if, after modification of the saturation and lightness of the pixel, the red value of the pixel is higher than both the green and blue values.

28. A method as claimed in any of claims 14 to 27, further comprising:
if the area, after correction, does not include a bright highlight region and dark pupil region therearound, modifying the saturation and lightness of the pixels in the area to give the effect of a bright highlight region and dark pupil region therearound.

29. A method as claimed in claim 28, further comprising:
determining if the area, after correction, substantially comprises pixels having high lightness and low saturation;
simulating a highlight region comprising a small number of pixels within the area;
modifying the lightness values of the pixels in the simulated highlight region so that the simulated highlight region comprises pixels with high lightness; and
reducing the lightness values of the pixels in the area outside the simulated highlight region so as to give the effect of a dark pupil.

30. A method as claimed in claim 29, further comprising increasing the saturation of the pixels in the simulated highlight region.

31. A method as claimed in claim 12 or 13, wherein the step of correcting some or all pixels in each area remaining in the list of areas to reduce the effect of red-eye is performed using a method as claimed in any of claims 14 to 30.

32. A method of correcting a red-eye feature in a digital image, comprising adding a simulated highlight region of pixels having a high lightness to the red-eye feature.

33. A method as claimed in claim 32, further comprising increasing the saturation of pixels in the simulated highlight region.

34. A method as claimed in claim 32 or 33, further comprising darkening the pixels in a pupil region around the simulated highlight region.

35. A method as claimed in claim 32, 33 or 34, further comprising:
identifying a flare region of pixels having high lightness and low saturation;
eroding the edges of the flare region to determine the simulated highlight region;
decreasing the lightness of the pixels in the flare region; and
increasing the lightness of the pixels in the simulated highlight region.

36. A method as claimed in any of claims 32 to 35, wherein the correction is not performed if a highlight region of light pixels is already present in the red-eye feature.

37. A method of detecting red-eye features in a digital image, comprising:
determining whether a red-eye feature could be present around a reference pixel in the image by attempting to identify an isolated, substantially circular area of correctable pixels around the reference pixel, a pixel being classed as correctable if it satisfies at least one set of predetermined conditions from a plurality of such sets.

38. A method as claimed in claim 37, wherein one set of predetermined conditions includes the requirements that:
the hue of the pixel is greater than or equal to about 220 or less than or equal to about 10;
the saturation of the pixel is greater than or equal to about 80; and
the lightness of the pixel is less than about 200.

39. A method as claimed in claim 37 or 38, wherein one set of predetermined conditions includes the requirements either that:
the saturation of the pixel is equal to 255; and
the lightness of the pixel is greater than about 150; or that:
the hue of the pixel is greater than or equal to about 245 or less than or equal to about 20;
the saturation of the pixel is greater than about 50;
the saturation of the pixel is less than (1.8×lightness−92);
the saturation of the pixel is greater than (1.1×lightness−90); and
the lightness of the pixel is greater than about 100.

40. A method as claimed in claim 37, 38 or 39, wherein one set of predetermined conditions includes the requirements that:
the hue of the pixel is greater than or equal to about 220 or less than or equal to about 10; and
the saturation of the pixel is greater than or equal to about 128.

41. A method as claimed in any of claims 12 to 31, wherein the step of attempting to find an isolated area which could correspond to a red-eye feature is performed using a method as claimed in any of claims 37 to 40.

42. A method as claimed in any of claims 12 to 41, wherein the step of analysing each area in the list of areas includes determining some or all of:
the mean of the hue, luminance and/or saturation of the pixels in the area;
the standard deviation of the hue, luminance and/or saturation of the pixels in the area;
the mean and standard deviation of the value of hue×saturation, hue×lightness and/or lightness×saturation of the pixels in the area;
the sum of the squares of differences in hue, luminance and/or saturation between adjacent pixels for all of the pixels in the area;
the sum of the absolute values of differences in hue, luminance and/or saturation between adjacent pixels for all of the pixels in the area;
a measure of the number of differences in lightness and/or saturation above a predetermined threshold between adjacent pixels;
a histogram of the number of correctable pixels having from 0 to 8 immediately adjacent correctable pixels;
a histogram of the number of uncorrectable pixels having from 0 to 8 immediately adjacent correctable pixels;
a measure of the probability of the area being caused by red-eye based on the probability of the hue, saturation and lightness of individual pixels being found in a red-eye feature; and
a measure of the probability of the area being a false detection of a red-eye feature based on the probability of the hue, saturation and lightness of individual pixels being found in a detected feature not caused by red-eye.

43. A method as claimed in claim 42, wherein the measure of the probability of the area being caused by red-eye is determined by evaluating the arithmetic mean, over all pixels in the area, of the product of the independent probabilities of the hue, lightness and saturation values of each pixel being found in a red-eye feature.

44. A method as claimed in claim 42 or 43, wherein the measure of the probability of the area being a false detection is determined by evaluating the arithmetic mean, over all pixels in the area, of the product of the independent probabilities of the hue, lightness and saturation values of each pixel being found in detected feature not caused by red-eye.

45. A method as claimed in any of claims 12 to 44, wherein the step of analysing each area in the list of areas includes analysing an annulus outside the area, and categorising the area according to the hue, luminance and saturation of pixels in said annulus.

46. A method as claimed in any of claims 42 to 45, wherein the step of validating the area includes comparing the statistics and properties of the area with predetermined thresholds and tests.

47. A method as claimed in claim 46, wherein the thresholds and tests used to validate the area depend on the type of feature and area detected.

48. A method as claimed in any of claims 12 to 47, wherein the step of removing some or all overlapping areas from the list of areas includes:
comparing all areas in the list of areas with all other areas in the list;
if two areas overlap because they are duplicate detections, determining which area is the best to keep, and removing the other area from the list of areas;
if two areas overlap or nearly overlap because they are not caused by red-eye, removing both areas from the list of areas.

49. Apparatus arranged to carry out the method of any preceding claim.

50. Apparatus as claimed in claim 49, which apparatus is a personal computer, printer, digital printing mini-lab, camera, portable viewing device, PDA, scanner, mobile phone, electronic book, public display system, video camera, television, digital film editing equipment, digital projector, head-up-display system, or photo booth.

51. A computer storage medium having stored thereon a program arranged when executed to carry out the method of any of claims 1 to 48.

52. A digital image to which has been applied the method of any of claims 1 to 48.
